(19) United States
(12) Patent Application Publication
(10) Pub. No.: US 2025/0356271 A1
(43) Pub. Date: Nov. 20, 2025

(54) SYSTEM OF AND METHOD FOR PERSONALIZED HEALTH-BASED TRAVEL

(71) Applicants: Chaithanya Renduchintala, Orlando, FL (US); University of Central Florida Research Foundation, Inc., Orlando, FL (US)

(72) Inventors: Robertico Croes, Orlando, FL (US); Dexter Hadley, Orlando, FL (US); Chaithanya Renduchintala, Orlando, FL (US)

(21) Appl. No.: 19/282,735

(22) Filed: Jul. 28, 2025

Related U.S. Application Data
(63) Continuation-in-part of application No. 18/403,347, filed on Jan. 3, 2024.
(60) Provisional application No. 63/436,780, filed on Jan. 3, 2023.

(51) Int. Cl. G06Q 10/02

(52) U.S. Cl. CPC G06Q 10/025

(57) ABSTRACT

Described herein relates to a system of and method for providing and booking a personalized health-based travel itinerary. The invention may comprise an integrated travel platform which may be configured to present a score computed by a multifactorial AI based decision support algorithm which draws data sets from curated public and private data sources in real time basis. Additionally, the integrated travel platform may integrate an accommodation and/or an experience digital framework which may greatly increase utility and expand the user base for the integrated travel platform, while democratizing the travel industry. As such, the digital framework may allow travel accommodation and/or experience service providers to participate proactively and/or reach out to niche traveler profiles specific to at least one user based on the following, including but not limited to, interests, health conditions, family circumstances, cultural considerations, and/or experiences that travelers or traveler groups seek.

### CROSS-REFERENCE TO RELATED APPLICATIONS

This nonprovisional application claims is a Continuation-in-Part of and claims the benefit of and priority to U.S. Nonprovisional patent application Ser. No. 18/403,347 entitled “SYSTEM OF AND METHOD FOR PERSONALIZED HEALTH-BASED TRAVEL” filed Jan. 3, 2024 by the same inventors, which claims priority to U.S. Provisional Patent Application No. 63/436,780 entitled “SYSTEM OF AND METHOD FOR PERSONALIZED HEALTH-BASED TRAVEL” filed Jan. 3, 2023 by the same inventors, all of which is incorporated herein by reference, in its entirety, for all purposes.

### BACKGROUND OF THE INVENTION

### 1. Field of the Invention

This invention relates, generally, to travel planning. More specifically, it relates to a system of and method for searching, providing, and/or booking a travel itinerary based on personalized health assessments.

### 2. Brief Description of the Prior Art

The travel and tourism industry are a highly competitive and collaborative market space. Travelers must make complex decisions based on constantly changing situations including but not limited to health condition, hyper local and regional changes, transportation options, cost, duration, group dynamics, climate, and many other factors. Additionally, organizations large and small are extremely protective about their data while they seek to collectively promote their region as a favorable destination.

Moreover, research shows that over 60 million Americans might be more inclined to travel if their disability needs are addressed in the planning stages of the travel. For this niche group of travelers, however, existing travel platforms often do not cater to the health and/or disability needs of the users. Instead, existing technologies typically aggregate and present travel, stay and activity options. The existing technologies are not true personalized decision support systems that address the time, mitigate risk, and enhance safety along with travel experience.

Furthermore, existing technologies are limited in the ability to ingest the variety and volume of data to generate a potential score which may be correlated with travel planning experience. In this manner, the existing technologies fail to implement and/or utilize a blockchain-based system configured to democratize the travel industry. In addition, existing technologies fail to provide any and all non-hedonic incentives such as meals plans, stay and services specific to disease conditions, such as senior living homes and other such targeted demographics.

Accordingly, what is needed is an integrated, accessible, and efficient integrated travel platform. However, in view of the art considered as a whole at the time the present invention was made, it was not obvious to those of ordinary skill in the field of this invention how the shortcomings of the prior art could be overcome.

### SUMMARY OF THE INVENTION

The long-standing but heretofore unfulfilled need, stated above, is now met by a novel and non-obvious invention disclosed and claimed herein. In an aspect, the present disclosure pertains to a computing device-implemented method for providing and/or booking a personalized health travel itinerary. In embodiments, the computer-implemented method may comprise the following steps: (a) providing, via a computing device having at least one processor, a plurality of safety topics on a display device associated with the computing device; (b) receiving, via at least one user interface communicatively coupled to the computing device, a set of parameters from at least one user based on at least one of the plurality of safety topics; (c) narrowing a plurality of travel packages based on the received set of parameters; (d) presenting the narrowed plurality of travel packages to the user; and (e) automatically booking in real-time, via the at least one processor of the computing device, at least one travel package selected by the user from the presented plurality of narrowed travel packages by: (i) based on a determination that the at least one selected travel package is available and/or comprises accurate pricing, providing, in real-time, a notification to the user indicative of a successful booking of the at least one selected travel package; and (ii) based on a determination that the at least one selected travel package is not available and/or does not comprise accurate pricing, providing, in real-time, a notification to the user indicative of an unsuccessful booking of the at least one selected travel package and/or presenting an updated plurality of travel packages to the user based on the received set of parameters.

In some embodiments, the computing device may also be communicatively coupled to at least one ARI and/or at least one API. In these other embodiment, the computing device-implemented method may further comprise the step of, receiving a pricing and/or an availability of the at least one selected travel package, in real-time. In this manner, the computing device-implemented method may also then comprise the step of, validating a pricing and/or an availability of the presented plurality of travel packages based on the determined real-time pricing and/or availability of the plurality of travel packages, via the at least one ARI and/or the at least one API. In these other embodiments, the computing device-implemented method may then further include the step of, updating the pricing and/or the availability of the presented plurality of travel packages to the real-time pricing and/or availability of the plurality of travel packages.

In some embodiments, the computing device-implemented method may also comprise the step of, presenting, via the display device associated with the computing device, a booking summary to the at least one user. In these other embodiments, the booking summary may comprise at least one booking metric, such that the at least one booking metric may include, but is not limited to a travel location, a room selection, air travel, events, activities, cancellation terms, refund terms, and/or a combination of thereof. As such, the computing device-implemented method may further comprise the step of, subsequent to automatically booking the at least one selected travel package, presenting, via the display device associated with the computing device, an acceptance page to the user, such that the acceptance page may confirm successful booking of the at least one selected travel package.

In some embodiments, the computing device-implemented method may further comprise the step of, determining, via at least one multifactorial algorithm and/or at least one causal algorithm, a safety score for each presented travel package based on the set of parameters provided by the at least one user. In these other embodiments, the safety score may comprise a data model based on an amount of crime and/or vulnerable subpopulations within an area about each of the plurality of travel packages. In this manner, the step of providing a plurality of safety topics to the user of the computing-device implemented method, may further comprise the step of, displaying, via the display device associated with the computing device, a colored map comprising the safety scores for each of the plurality of presented travel packages, such that the colored map may comprise a range of colors corresponding to a range of low safety scores to high safety scores.

In some embodiments, the notification indicative of successful booking and/or an unsuccessful booking may comprise a stimulus including but not limited to auditory, haptic, visual, and/or a combination of thereof.

Moreover, another aspect of the present disclosure pertains to a personalized travel health itinerary optimization system for automatically providing and/or booking a personalized health travel itinerary. In an embodiment, the personalized travel health itinerary optimization system may comprise the following: (a) a computing device having at least one processor, such that the at least one processor may be communicatively coupled to a display device; and (b) a non-transitory computer-readable medium operably coupled to the processor, the computer-readable medium having computer-readable instructions stored thereon that, when executed by the processor, cause the personalized travel health itinerary optimization system to automatically provide and/or book the personalized health travel itinerary, the personalized travel health itinerary by executing instructions comprising: (i) providing, via a computing device having at least one processor, a plurality of safety topics on a display device associated with the computing device; (ii) receiving, via at least one user interface communicatively coupled to the computing device, a set of parameters from at least one user based on at least one of the plurality of safety topics; (iii) narrowing a plurality of travel packages based on the received set of parameters; (iv) presenting the narrowed plurality of travel packages to the user; and (v) automatically booking in real-time, via the at least one processor of the computing device, at least one travel package selected by the user from the presented plurality of narrowed travel packages by: (A) based on a determination that the at least one selected travel package is available and/or comprises accurate pricing, providing, in real-time, a notification to the user indicative of a successful booking of the at least one selected travel package; and (B) based on a determination that the at least one selected travel package is not available and/or does not comprise accurate pricing, providing, in real-time, a notification to the user indicative of an unsuccessful booking of the at least one selected travel package and/or presenting an updated plurality of travel packages to the user based on the received set of parameters.

In some embodiments, the computing device may also be communicatively coupled to at least one ARI and/or at least one API. In these other embodiment, the executed instructions may further comprise the step of, receiving a pricing and/or an availability of the at least one selected travel package, in real-time. In this manner, the executed instructions may also then comprise the step of, validating a pricing and/or an availability of the presented plurality of travel packages based on the determined real-time pricing and/or availability of the plurality of travel packages, via the at least one ARI and/or the at least one API. In these other embodiments, the executed instructions may then further include the step of, updating the pricing and/or the availability of the presented plurality of travel packages to the real-time pricing and/or availability of the plurality of travel packages.

In some embodiments, the executed instructions may further comprise the step of, determining, via at least one multifactorial algorithm and/or at least one causal algorithm, a safety score for each presented travel package based on the set of parameters provided by the at least one user. In these other embodiments, the safety score may comprise a data model based on an amount of crime and/or vulnerable subpopulations within an area about each of the plurality of travel packages. In this manner, the step of providing a plurality of safety topics to the user of the executed instructions, may further comprise the step of, displaying, via the display device associated with the computing device, a colored map comprising the safety scores for each of the plurality of presented travel packages, such that the colored map may comprise a range of colors corresponding to a range of low safety scores to high safety scores.

Furthermore, in some embodiments, the present invention pertains to an integrated travel platform configured to expand the reach (e.g., user base and/or user roles) and/or depth (location, accommodation, and/or experience) of a standard travel booking platform. In embodiments, the integrated travel platform may comprise at least one service matching algorithm, at least one decision based algorithm, and/or a blockchain-based transaction system to facilitate the minting, transfer, purchase, lease, and/or sale of at least one digital token to facilitate travel planning, review, and/or transaction efficiency of the integrated travel platform for at least one user. Additionally, in these other embodiments, the integrated travel platform may be configured to measure the level of trust of the at least one user and/or a plurality of service providers based on at least one review provided by the at least one user and/or the amount of digital tokens generated and/or provided to the at least one user and/or the plurality of service providers. As such, the integrated travel platform may be configured to build confidence and/or continually improve trust of the at least one user in all aspects of the integrated travel platform.

As such, in some embodiments, the integrated travel platform may be configured to integrate and/or implement a substantial variety and/or volume of data to generate a score that can be correlated with travel planning experience.

Furthermore, in some embodiments, the integrated travel platform may comprise a display device, such that the display device is configured to show the layout (e.g., colored range map) which may have been developed and/or integrated with an algorithm. In addition, in these other embodiments, the at least one service matching algorithm of the integrated travel platform may be extended to include, but is not limited to, climatic, medical, political, and/or interpersonal relational features that may impact an outcome of travel satisfaction of the at least one user. In this manner, at least one curated data set may be extended to health records and/or social media to further personalize the recommendations.

In some embodiments, the integrated travel platform may comprise at least one a travel planning website and/or service, such that the at least one travel planning website and/or service may be configured to cater to the needs of various populations and/or subgroups with specific vulnerabilities. These vulnerabilities may include but are not limited to compromised immune systems, diabetic conditions, allergies, regional and local cuisine, food preferences, and/or religious groups focused on certain types of experiences.

In addition, in some embodiments, the integrated travel platform may also be configured to integrate and/or correlate a city-level matter data, for example, such as the size of city facilities available in the city transportation network built into the city mode of transportation within the city, social services, and/or other travel-related themes. In this manner, the city-level matter data may be provided by the at least one user by the integrated travel platform based on a particular designated travel location, along with specific travel-related microservices such as hotel rooms, Airbnb, specialty chefs, home-based care, dedicated travel agents, and/or Mom and Pop services, based on a plurality of travel topics inputted into the integrated travel platform by the at least one user. As such, in these other embodiments, the services center on specific traveler needs along with geographic and temporal features such as weather patterns, pollution, temperature, and/or humidity, all of which may impact experience and satisfaction that may change over time.

In some embodiments, the integrated travel platform may be configured to provide a city leadership consulting services, such that the city leadership may be provided at least one recommendation by the integrated travel platform on how the city leadership might be able to monetize certain specific groups of travelers and/or position at least one fragmented travel service network provider as leaders in catering to the needs of specific vulnerable groups. Additionally, in these other embodiments, the integrated travel platform may, through its network of vulnerable population groups and health associations, promote via quantitative recommendation engine, destinations, and/or travel service networks tokenized on the blockchain-based transaction system to potential tourists and potential consumers of those services, the vulnerable patients.

In this manner, the integrated travel platform may be configured to invite at least one user with at least one medical health issue to register into the memory of the integrated travel platform and/or create a profile specific to the at least one user within the memory of the integrated travel platform. In addition, in some embodiments, at least one of the plurality of service providers may also be invited by the integrated travel platform to register within the memory of the integrated travel platform and/or create a profile specific to each of the plurality of service providers. In these other embodiments, the plurality of service providers may include but are not limited to medical and/or alternative life support service providers, such as cooks' daily care. As such, in some embodiments, when the profile specific to the at least one user and/or to at least one of the plurality of service providers has been created, the service matching algorithm of the integrated travel platform may be configured to match appropriate groups of service providers to at least one need of the at least one user and/or the integrated travel platform may be configured to provide at least one recommendation to the at least one user and/or at least one of the plurality of service providers, such that the challenge of planning, traveling, and/or making selections of the at least one user may be substantially reduced, optimizing the travel booking process.

Additionally, in some embodiments, the integrated travel platform may enable at least one of the plurality of service providers to build collaborative networks to serve specific groups of travelers with particular interests and limitations. Moreover, in these other embodiments, the integrated travel platform may comprise at least one intuitive user-interface and/or display device, such that the display device may be configured to present a score computed by a multifactorial artificial intelligence (hereinafter “AI”) of the integrated travel platform based on a decision support algorithm which draws data sets from curated public and private data sources in real time basis. In addition, the decision support algorithm of the integrated travel platform may be configured to factor at least one individualized preference of the at least one user into the score presented to the at least one user.

Additional aspects and advantages of the present disclosure will become readily apparent to those skilled in this art from the following detailed description, wherein only illustrative embodiments of the present disclosure are shown and described. As will be realized, the present disclosure is capable of other and different embodiments, and its several details are capable of modifications in various obvious respects, all without departing from the disclosure. Accordingly, the drawings and description are to be regarded as illustrative in nature, and not restrictive.

The invention accordingly comprises the features of construction, combination of elements, and arrangement of parts that will be exemplified in the disclosure set forth hereinafter and the scope of the invention will be indicated in the claims.

### BRIEF DESCRIPTION OF THE DRAWINGS

For a fuller understanding of the invention, reference should be made to the following detailed description, taken in connection with the accompanying drawings, in which:

FIG. 1 is a graphic illustration depicting a flow diagram of modules for an integrated travel platform, according to embodiments of the present disclosure.

FIG. 2 is a graphic illustration depicting an exemplary process flow diagram of a method of digitally booking a travel safety itinerary and providing real-time recommendations, availability and prices in order to aid a user's travel booking performance, according to embodiments of the present disclosure.

FIG. 3 is a graphic illustration depicting an exemplary architecture diagram of an integrated travel platform, according to embodiments of the present disclosure.

FIG. 4 is a graphic illustration depicting an exemplary knowledge graph of an integrated travel platform, according to embodiments of the present disclosure.

FIG. 5 is a graphic illustration depicting an exemplary configuration of a user-interface of an integrated health travel platform, according to embodiments of the present disclosure.

FIG. 6 is a graphic illustration depicting an exemplary configuration of a health preference profile of an integrated health travel platform, according to embodiments of the present disclosure.

### DETAILED DESCRIPTION OF THE INVENTION

In the following detailed description of the preferred embodiments, reference is made to the accompanying drawings, which form a part thereof, and within which are shown by way of illustration specific embodiments by which the invention may be practiced. It is to be understood that one skilled in the art will recognize that other embodiments may be utilized, and it will be apparent to one skilled in the art that structural changes may be made without departing from the scope of the invention.

As such, elements/components shown in diagrams are illustrative of exemplary embodiments of the disclosure and are meant to avoid obscuring the disclosure. Any headings, used herein, are for organizational purposes only and shall not be used to limit the scope of the description or the claims.

Furthermore, the use of certain terms in various places in the specification, described herein, are for illustration and should not be construed as limiting. For example, any reference to an element herein using a designation such as “first,” “second,” and so forth does not limit the quantity or order of those elements, unless such limitation is explicitly stated. Rather, these designations may be used herein as a convenient method of distinguishing between two or more elements or instances of an element. Therefore, a reference to first and/or second elements does not mean that only two elements may be employed there or that the first element must precede the second element in some manner. Also, unless stated otherwise a set of elements may comprise one or more elements.

Reference in the specification to “one embodiment,” “preferred embodiment,” “an embodiment,” or “embodiments” means that a particular feature, structure, characteristic, or function described in connection with the embodiment is included in at least one embodiment of the disclosure and may be in more than one embodiment. The appearances of the phrases “in one embodiment,” “in an embodiment,” “in embodiments,” “in alternative embodiments,” “in an alternative embodiment,” or “in some embodiments” in various places in the specification are not necessarily all referring to the same embodiment or embodiments. The terms “include,” “including,” “comprise,” and “comprising” shall be understood to be open terms and any lists that follow are examples and not meant to be limited to the listed items.

Referring in general to the following description and accompanying drawings, various embodiments of the present disclosure are illustrated to show its structure and method of operation. Common elements of the illustrated embodiments may be designated with similar reference numerals.

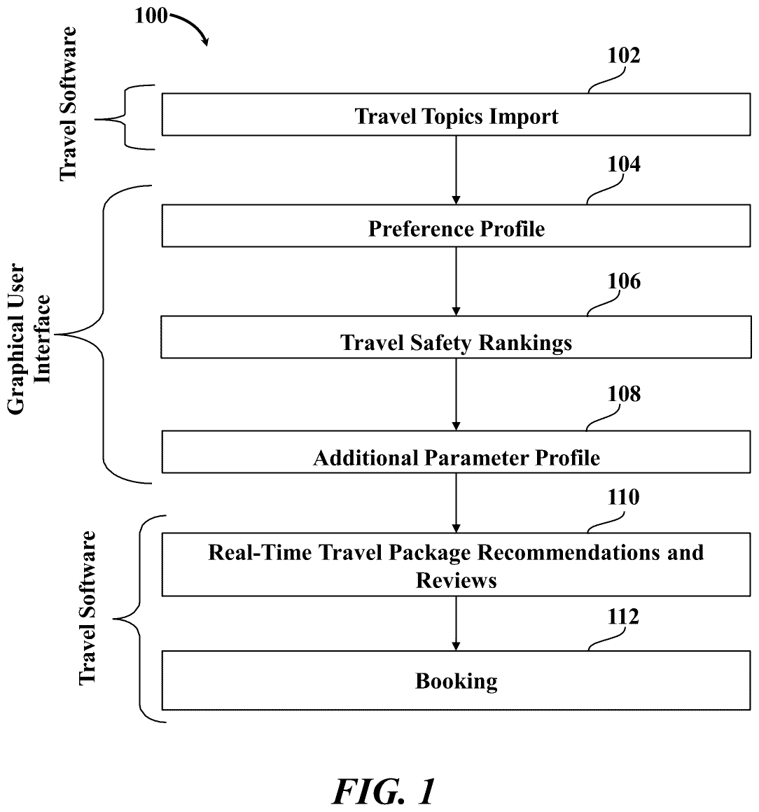

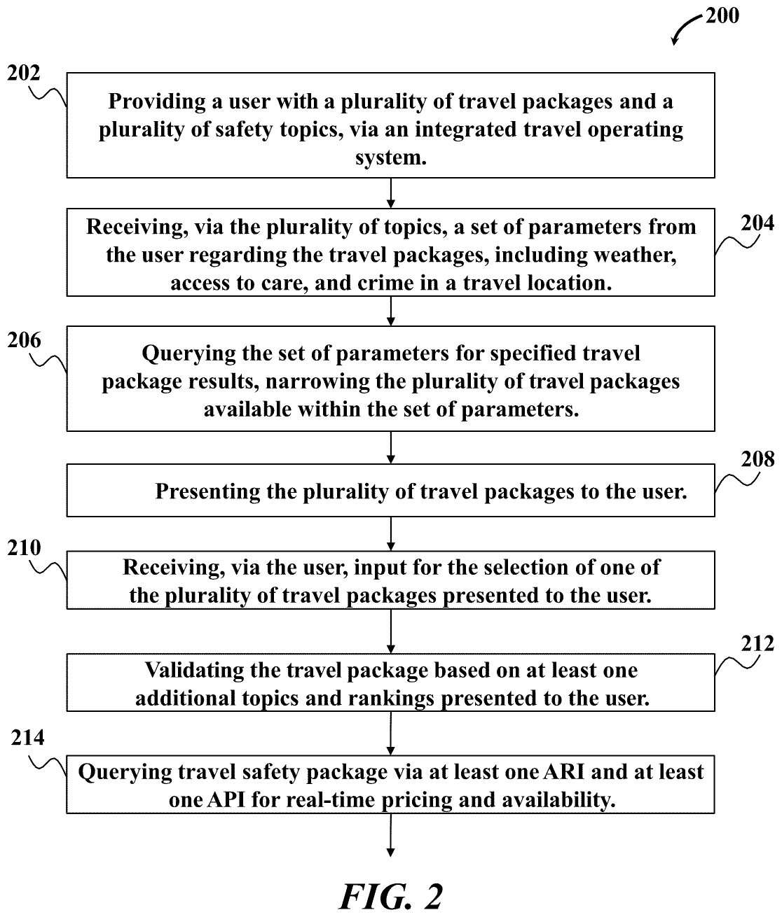

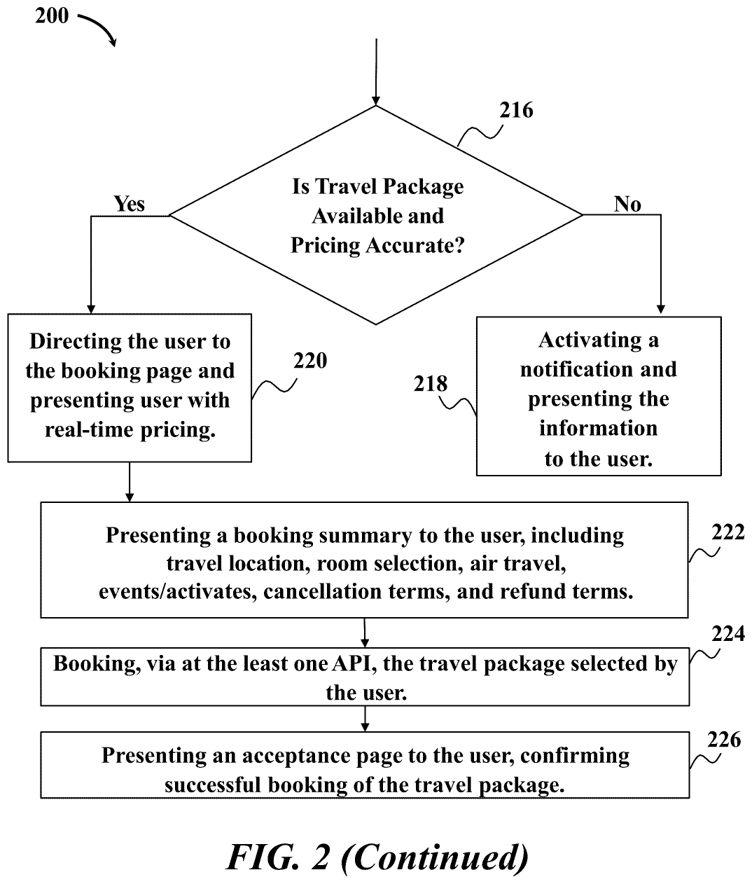

Accordingly, the relevant descriptions of such features apply equally to the features and related components among all the drawings. For example, any suitable combination of the features, and variations of the same, described with components illustrated in FIG. 1, can be employed with the components of FIG. 2, and vice versa. This pattern of disclosure applies equally to further embodiments depicted in subsequent figures and described hereinafter. It should be understood that the figures presented are not meant to be illustrative of actual views of any particular portion of the actual structure or method but are merely idealized representations employed to more clearly and fully depict the present invention defined by the claims below.

### Definitions

As used in this specification and the appended claims, the singular forms “a,” “an,” and “the” include plural referents unless the content clearly dictates otherwise. As used in this specification and the appended claims, the term “or” is generally employed in its sense including “and/or” unless the context clearly dictates otherwise.

The computer readable medium described in the claims below may be a computer readable signal medium or a computer readable storage medium. A computer readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computer readable storage medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this document, a computer readable storage medium may be any tangible medium that can contain or store a program for use by or in connection with an instruction execution system, apparatus, or device.

A computer readable signal medium may include a propagated data signal with computer readable program PIN embodied therein, for example, in baseband or as part of a carrier wave. Such a propagated signal may take any of a variety of forms, including, but not limited to, electro-magnetic, optical, or any suitable combination thereof. A computer readable signal medium may be any computer readable medium that is not a computer readable storage medium and that can communicate, propagate, or transport a program for use by or in connection with an instruction execution system, apparatus, or device.

Program PIN embodied on a computer readable medium may be transmitted using any appropriate medium, including but not limited to wireless, wire-line, optical fiber cable, radio frequency, etc., or any suitable combination of the foregoing. Computer program PIN for carrying out operations for aspects of the present invention may be written in any combination of one or more programming languages, including an object oriented programming language such as Java, C#, C++, Python, MATLAB, and/or the like and conventional procedural programming languages, such as the “C” programming language or similar programming languages.

Aspects of the present invention are described below with reference to flowchart illustrations and/or block diagrams of methods, apparatus (systems) and computer program products according to embodiments of the invention. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored in a computer readable medium that can direct a computer, other programmable data processing apparatus, or other devices to function in a particular manner, such that the instructions stored in the computer readable medium produce an article of manufacture including instructions which implement the function/act specified in the flowchart and/or block diagram block or blocks.

The computer program instructions may also be loaded onto a computing device, other programmable data processing apparatus, or other devices to cause a series of operational steps to be performed on the computer, other programmable apparatus or other devices to produce a computer implemented process such that the instructions which execute on the computer or other programmable apparatus provide processes for implementing the functions/acts specified in the flowchart and/or block diagram block or blocks.

As used herein, the term “communicatively coupled” refers to any coupling mechanism configured to exchange information (e.g., at least one electrical signal) using methods and devices known in the art. Non-limiting examples of communicatively coupling may include Wi-Fi, Bluetooth, wired connections, wireless connection, quantum, and/or magnets. For ease of reference, the exemplary embodiment described herein refers to Wi-Fi and/or Bluetooth, but this description should not be interpreted as exclusionary of other electrical coupling mechanisms.

As used herein, the terms “about,” “approximately,” or “roughly” refer to being within an acceptable error range (i.e., tolerance) for the particular value as determined by one of ordinary skill in the art, which will depend in part on how the value is measured or determined (e.g., the limitations of a measurement system), (e.g., the degree of precision required for a particular purpose, such as generating and/or booking a personalized health travel itinerary). As used herein, “about,” “approximately,” or “roughly” refer to within ±25% of the numerical.

All numerical designations, including ranges, are approximations which are varied up or down by increments of 1.0, 0.1, 0.01 or 0.001 as appropriate. It is to be understood, even if it is not always explicitly stated, that all numerical designations are preceded by the term “about”. It is also to be understood, even if it is not always explicitly stated, that the compounds and structures described herein are merely exemplary and that equivalents of such are known in the art and can be substituted for the compounds and structures explicitly stated herein.

Wherever the term “at least,” “greater than,” or “greater than or equal to” precedes the first numerical value in a series of two or more numerical values, the term “at least,” “greater than” or “greater than or equal to” applies to each of the numerical values in that series of numerical values. For example, greater than or equal to 1, 2, or 3 is equivalent to greater than or equal to 1, greater than or equal to 2, or greater than or equal to 3.

Wherever the term “no more than,” “less than,” or “less than or equal to” precedes the first numerical value in a series of two or more numerical values, the term “no more than,” “less than” or “less than or equal to” applies to each of the numerical values in that series of numerical values. For example, less than or equal to 1, 2, or 3 is equivalent to less than or equal to 1, less than or equal to 2, or less than or equal to 3.

### Integrated Travel Platform

The present invention pertains to an integrated travel platform which may incorporate ARI and/or API software. The integrated travel platform may include an integrated platform—such as a website, a mobile application, and/or any software known in the art applicable to any computing device known in the art—that may interact with user through at least one graphical user interface, and/or may provide the user, with a significantly eased travel searching and/or booking experience through the at least one travel package, removing any need to personally plan, explore, and/or book individual components of the desired vacation, business trip, and/or travel itinerary based on at least one personalized safety preference of the user. As such, in embodiments, the integrated travel platform may comprise a computing device having at least one processor, at least one user interface, and/or at least one display device associated with the computing device.

In embodiments, the integrated travel package platform may selectively verify and/or cache at least one travel topic (hereinafter “safety topic”). As such, the integrated travel platform, via API, may be configured to perform at least one inquiry for a specified safety topic of the user and/or may import any associated data of the specified safety topic (e.g., personalized user safety standards, user travel satisfaction, at least one destination, user travel recommendations, travel package reviews, and/or at least one user consideration) into a local dataset within the computing device. Subsequently, in these embodiments, the integrated travel package platform may also be configured to cache the ARI of the at least one safety topic and/or save all imported data within the local data set. Furthermore, the integrated travel package platform may also be configured to associate certain preference profiles with the at least one safety topic, allowing the user, via the at least one processor of the computing device, to find the at least one safety topic via selecting the certain preference profiles.

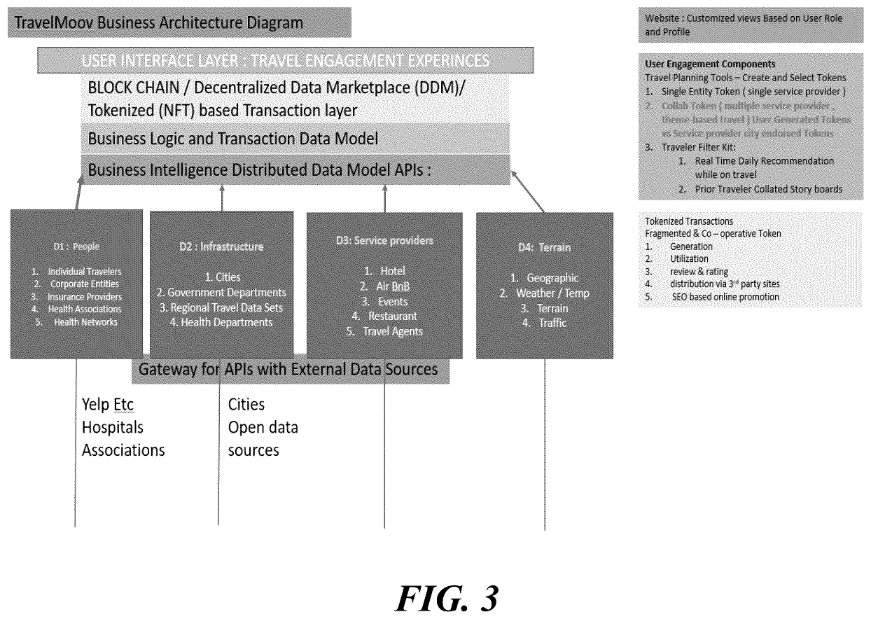

FIG. 1, in conjunction with FIG. 3, depicts a flow diagram of modules for the integrated travel platform, according to an embodiment of the present disclosure. In embodiments, the integrated travel package platform 100 may include several aspects within the system. In these embodiments, the integrated travel platform 100 may have a safety topics import aspect 102, a preference profile aspect 104, a travel safety rankings aspect 106, an additional parameter profile aspect 108, a real-time safety package recommendation, review and/or pricing aspect 110, and/or a booking aspect 112. In these embodiments, the safety topic import 102, the real-time safety package availability, recommendations, reviews, and/or pricing aspect, and/or the booking aspect 112 are primarily software based only. The preference profile aspect 104, the safety packages aspect 106, and additional parameter profile aspect 108 allow a user to interact with the integrated travel platform 100, via the graphical user interface of a computing device. Each of these aspects will be further described in the other sections of this patent document.

FIG. 2 depicts an exemplary process flow diagram depicting a method of digitally providing and/or booking a travel package on a computing device and providing real-time availability and prices of the travel package in order to aid a user's travel booking performance, according to an embodiment of the present disclosure. As such, the steps delineated in FIG. 2 are merely exemplary of an order of digitally searching and/or booking the travel package on the computing device. The steps may be carried out in another order, with or without additional steps included therein.

As shown in FIG. 2, in embodiments, method 200 begins at step 202, in which the integrated travel platform may provide the user with a plurality of travel packages and/or a plurality of safety topics. In this manner, this step may include communicatively coupling a blockchain-based transaction system, ARI, and/or API to the integrated travel platform, such that the integrated travel platform may be configured to search and/or cache data of the plurality of safety topics within the travel package. In some embodiments, the integrated travel platform may comprise the blockchain-based transaction system, ARI, and/or API within the software of the integrated travel platform to search and/or cache data of the plurality of safety topics within the travel package.

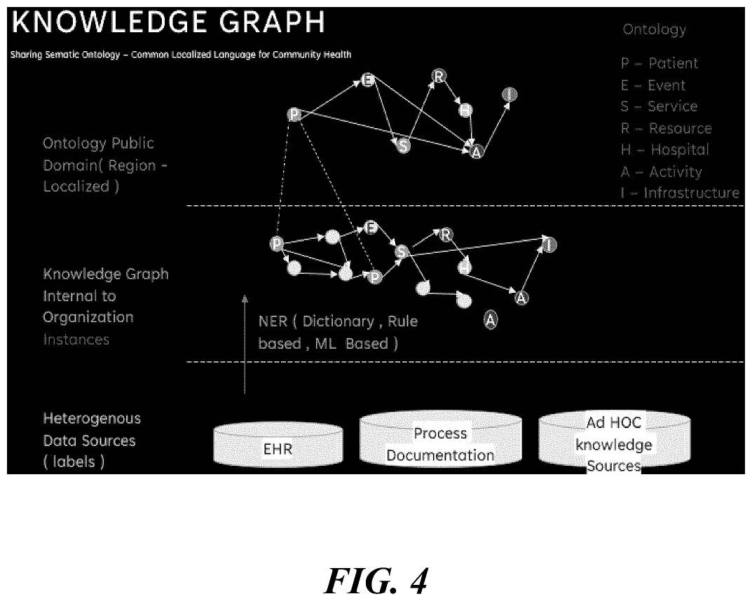

Next, as shown in FIG. 2, in conjunction with FIG. 4, at step 204, the integrated travel platform may be configured to receive, via the plurality of safety topics, at least one parameter from the user regarding the at least one travel package. In embodiments, the set of parameters from the user may include, but is not limited to, weather, pollution, social safety and/or transport, access to care, access to facilities, entertainment options, therapy, home-based care, community work availability, event planner availability, and/or meal provider availability.

In addition, in embodiments, the integrated travel platform may also comprise at least one memory (e.g., distributed ledger) associated with the computing device, such that the integrated travel platform may be configured to automatically capture, in real-time, at least one disease condition of at least one travel location based on the at least one parameter from the user. Accordingly, in these embodiments, the integrated travel platform may update the profiles of the traveler and/or the service provider and/or suggest at least one travel package within the travel location selected by the user and/or at least one alternative travel package within at least one alternative travel location comprising similar features as defined by the at least one parameter provided by the user, based on the real-time disease condition of the travel location selected by the user.

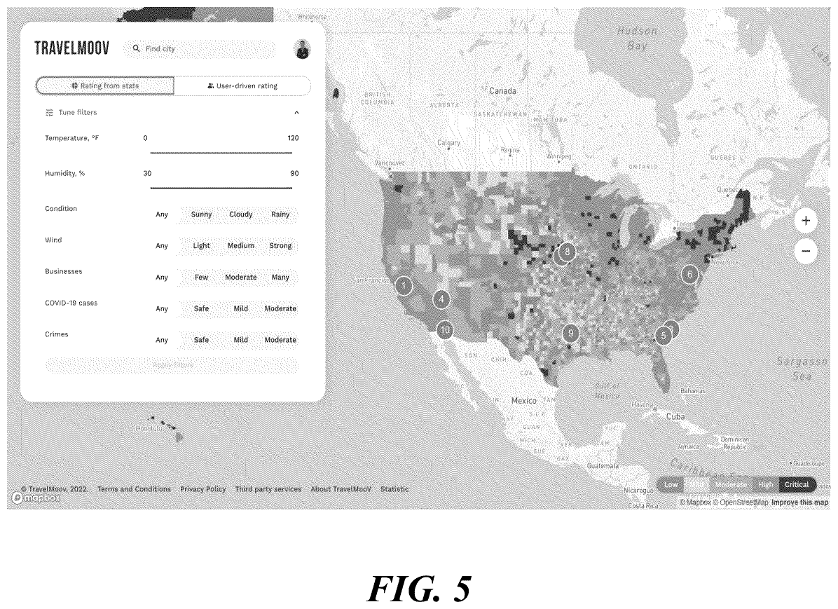

Further, as shown in FIG. 2, at step 206 of method 200, in embodiments, the integrated travel platform may be configured to query the set of parameters for certain travel package results that may be closely related to the plurality of safety topics selected by the user. In these embodiments, as shown in FIG. 2, in conjunction with FIG. 5, at step 208, the plurality of travel packages may be presented to the user via the interface of the computing device. In this manner, the plurality of travel packages presented to the user may be automatically narrowed based on the set of parameters provided by the user.

Accordingly, in embodiments, method 200 may proceed to step 208, in which a score may be presented to the user. As such, in these embodiments, the score may comprise an overall safety rating of the travel package based on the at least one safety parameter selected by the user and/or integrated into the set of the at least one parameter from the user. Moreover, the integrated travel platform may comprise at least one multifactorial AI configured to automatically draw at least one data set from at least one curated public and/or private data source in real-time. In addition, the multifactorial AI may also be configured to factor in at least one alternative preference of the user based on at least one secondary safety topic provided by the user in the set of the at least one parameter provided by the user for the travel package. As such, the multifactorial AI may calculate and/or rank at least one travel location from optimally suited to worst-suited based on the at least one preference and/or at least one alternative preference inputted into the integrated travel platform via the user.

Furthermore, in embodiments, the integrated travel platform may comprise at least one optimized recommendation engine algorithm, such that the at least one recommendation engine algorithm may comprise item-to-item collaborative filtering, user-to-user collaborative filtering and/or content-based filtering based on prior associated data inputted by the at least one user and/or at least one alternative user, with respect to the at least one safety parameter. In this manner, the integrated travel platform, via the at least one recommendation engine algorithm, may be configured to train and/or retrain the prior associated data with inputted data provided by the at least one user (e.g., a multi-stakeholder system), such that the integrated travel platform may minimize data preprocessing required and/or leverage the at least one recommendation engine algorithm and/or transfer learning models, improving recommendations and variety of services recommended to the at least one user based on the at least one safety parameter.

Additionally, in embodiments, the integrated travel platform may be configured to facilitate a democratization of travel and/or provide optimized travel package recommendations to the at least one user by incorporating at least one collaborative filtering algorithm within the at least one recommendation engine algorithm. Accordingly, in these embodiments, the integrated travel platform may be configured to allow at least one service provider and/or at least one alternative travel recommendation platform may import an associated dataset into the integrated travel platform, reducing the barriers imposed by big data capitalism. In this manner, the at least one collaborative filtering algorithm may be configured to incorporate the associated dataset provided by the at least one service provider and/or at least one alternative travel recommendation platform to train and/or retrain the prior associated data, such that the integrated travel platform may optimize travel package recommendations for the at least one user.

Referring again to FIG. 2, in embodiments, following presenting the plurality of travel packages to the user, in embodiments, at step 210 of method 200, the integrated travel platform may receive at least one input for the selection of one of the plurality of travel packages presented to the user. In these embodiments, when the user selects one of the plurality of the travel packages, the user may be sent to the booking page. However, before the user is sent to the booking page, at step 212 of method 200, respectively, the integrated travel platform may present at least one additional parameter to the user to verify the availability of the travel package to the user. As such, in these embodiments, the additional parameters may include, but not limited to, age, allergies, total amount of users that have selected a same and/or a similar travel package, and/or at least one review and/or rating by at least one former traveler. Accordingly, the integrated travel platform may be configured to allow the user to interact with the graphical user interface, such that the user may compare at least one review and/or rating of a former traveler with at least one review and/or rating of the user.

As shown in FIG. 3, in embodiments, the integrated travel platform may also be used without any personalized information. However, the user may want to personalize each experience, keep travel filter settings, and/or a history which requires a user account associated with the integrated travel platform based on the preferences of the user. Accordingly, in these embodiments, the user authentication may be through the at least one API (e.g., Google Static API). Furthermore, the integrated travel platform may be configured to filter at least one safety topic based on quantitative and/or qualitative aspects and/or ranges. For example, in some embodiments, the filter may be based on Temperature (e.g., Quantitative), Humidity (e.g., Quantitative), and/or subsequent to filtering based on quantitative aspects, the integrated travel platform may then quartile ranges based on the distribution of scores reported by API for Wind, infectious disease (e.g., Covid-19) prevalence, personalized risk (e.g., based on health information provided by a user), and/or Crimes. Additionally, in some embodiments, the integrated travel platform may classify quantitative aspects within a plurality of search terms, for example, weather may be classified using search terms, including but not limited to “any”, “Sunny” “Cloudy” and/or “Rainy” that can be served by API.

Moreover, in embodiments, as shown in FIG. 3, the integrated travel platform may be configured to track a rating of at least one user account when the at least one user logs into the integrated travel platform. Additionally, in these embodiments, the integrated travel platform may provide at least one rating on a location, which may be comprised of an average at least one alternative rating by each user and/or alternative user.

Additionally, in embodiments, the integrated travel platform may be configured to backend at least one query from the user and/or various data sources. In this manner, in these embodiments, the at least one query may occur on a daily basis and/or any timeframe known in the art associated with updating a database and/or the integrated travel platform may be configured to save the results to a memory of the computing device associated with the integrated travel platform. As such, any information saved to the memory of the computing device of the integrated travel platform may be displayed on a display device associated with the computing device (e.g., infectious disease (e.g., Covid-19) prevalence information and/or personalized risk score and/or ranking every day at 07:00 AM/PM, mobility information every day at 08:00 AM/PM, yelp data every day at 09:00 AM/PM, crime data at 06:00 AM/PM on Mondays, and/or weather data every day at 05:00 AM/PM).

Moreover, in embodiments, the integrated travel platform may be configured to integrate a new travel package, via the at least one multifactorial AI and/or blockchain-based transaction system, based on the at least one additional parameter selected by the user. In this manner, the multifactorial AI may be configured to retain at least one parameter provided by the user in a memory of the computing device, such that the integrated travel platform may provide the user with a travel behavior based on past user selections, including but not limited to, at least one safety topic, at least one parameter, and/or at least one travel package.

In embodiments, the integrated travel platform may be configured to ingest and/or integrate personalized health data of the at least one user with a plurality of travel safety parameters to generate a tailored travel itinerary. Specifically, the integrated travel platform may invite the user to create a detailed health profile stored in the memory of the computing device (e.g., conditions like allergies, mobility limitations, immunocompromised status, or dietary needs). As such, this profile data can be cross-linked with safety-related parameters (such as local environmental conditions and healthcare availability at potential destinations) within the itinerary planning engine. By incorporating the at least one user's health metrics and preferences as first-class parameters, the integrated travel platform may ensure that any travel package retrieved by the at least one processor aligns not only with general interests but also with the user's individual health and/or safety requirements. In this manner, in these embodiments, the challenge of manually filtering travel options for personal health concerns may be substantially reduced, optimizing the travel booking process through automation.

In embodiments, the data flow of the integrated travel platform may be engineered to gather and/or fuse diverse data streams (e.g., personal health inputs from the user interface and external safety data) in real time. For example, as shown in FIG. 2, in conjunction with FIG. 3 and FIG. 4, in some embodiments, at an initial step of itinerary planning, the integrated travel platform communicatively couples to various data sources (e.g., public health databases, environmental sensor APIs, crime statistics services) via network interfaces and APIs. The at least one processor may automatically pull current safety parameters, including but not limited to regional disease outbreak levels, pollution indices, climate conditions, and/or crime rates for each prospective travel location. Simultaneously, the user's health profile data (e.g., stored in a database and/or distributed ledger memory associated with the integrated travel platform) can then be retrieved and/or merged with these safety datasets. In this manner, in these other embodiments, a local caching mechanism in the memory of the integrated travel platform may store recent safety topic data (e.g., latest epidemiological data or hospital availability in the area) to accelerate query response times. This comprehensive data ingestion pipeline allows the itinerary planning module to evaluate travel options against a rich context of personal health factors and/or location-specific safety criteria in parallel, leveraging multi-threaded processing to handle the multifactorial input without latency.

Moreover, in embodiments, the multifactorial AI (e.g., an itinerary planning algorithm) of the integrated travel platform may leverage the combined dataset to dynamically tailor travel package recommendations. As such, a decision support engine of the integrated travel platform (which may include at least one service matching algorithm and/or at least one decision-based algorithm) can analyze the health requirements of the at least one user in light of the safety profile of each candidate destination or service. For example, in some embodiments, if the user profile of the at least one user indicates a respiratory condition, the decision support engine may automatically correlate the respiratory condition with air quality and/or pollen index data in each destination's safety parameters. As such, travel packages in areas exceeding a pollution threshold may be programmatically de-emphasized or filtered out by the algorithm. Conversely, locations with favorable health-supportive parameters (e.g., mild climate and proximity to medical facilities) may be ranked higher. Accordingly, in embodiments, the integrated travel platform may continually compare the set of user-defined health constraints against each travel location's risk indicators (retrieved via APIs in real time) and/or can compute a suitability score or matching level, described in further detail below. As such, in these embodiments, the platform can intelligently narrow the plurality of travel packages based on both traditional travel preferences and/or the integrated personalized health safety factors, ensuring that presented options adhere to the user's well-being needs.

In embodiments, the memory architecture of the integrated travel platform may maintain an up-to-date repository of health and/or safety information that directly feeds a recommendation logic of the decision support engine of the integrated travel platform. In these embodiments, the integrated travel platform can also include a distributed ledger and/or similar secure memory store which may automatically capture real-time health status data for destinations (for example, infectious disease prevalence or emergency services availability) as soon as the user inputs a related parameter. This information may then be written into the user's planning context in memory and/or may trigger automatic itinerary adjustments. For example, in some embodiments, if the user is interested in a particular city, the integrated travel platform may detect via its health data feeds of the decision support engine that a new travel advisory or outbreak alert was issued for that region. In response, the processor of the integrated travel platform can execute instructions to update the user's profile and/or itinerary options: the system might then suggest at least one alternative travel location with comparable attributes (e.g., scenery, culture, and activities) but safer health conditions. As such, these internal operations can rely on continuously updated tables of location attributes and/or user health tolerance thresholds stored in non-volatile storage and/or RAM, enabling the platform to react to changing data in real time. By correlating personal medical data with external safety triggers, the integrated travel platform can improve reliability and/or responsiveness, automatically guiding users toward itineraries that are both enjoyable and medically appropriate.

Furthermore, in embodiments, the integration of personalized health data may also extend to how the platform interacts with third-party systems during itinerary formulation. The computing device and/or the processor of the integrated travel platform may be communicatively coupled, via at least one API or data feed, to external health and safety information systems, as shown in FIG. 3, for example, retrieving hospital network locations, pharmacy availability, and/or even local healthy food options in the vicinity of lodging. These data points may then be ingested through secure API calls and/or stored in the platform's travel package database as metadata for each option (e.g., tagging a hotel or experience with indicators like “wheelchair accessible” or “near 24 hr clinic”). During the itinerary planning computation, in embodiments, the processor of the integrated travel platform may aggregate these tags with user-specific needs from the profile. As such, a rule-based engine and/or machine learning model in the software of the integrated travel platform may then score each travel package by how well it satisfies the health-based tags required by the user. For example, in some embodiments, a travel package that includes a stay at a hotel with on-site medical support or a kitchen capable of handling the user's allergy-based diet may be programmatically elevated in the recommendations. All such third-party data integration may then be managed through the platform's network interface layer, which can handle authentication to external services, periodic data updates (e.g., nightly refresh of health statistics), and/or error-checking (to ensure data integrity before it influences the itinerary). This robust integration of external health data feeds into the internal database ensures that the system's recommendations remain data-driven and current without placing the burden on the user to perform manual research.

Accordingly, the comprehensive fusion of personal health information with safety parameters optimizes both computing performance and/or user experience in travel planning. In this manner, in embodiments, by preemptively filtering and/or scoring travel options through the lens of the user's health profile, the integrated travel platform can reduce the processing needed during later stages of booking (since unsuitable options are eliminated early, fewer iterative searches or changes are required). In addition, the user interface can be able to present a refined list of travel packages that have already been validated against critical health constraints, which means subsequent interactive queries (such as availability checks or booking steps) operate on a smaller, more relevant data set, improving overall system efficiency. In these embodiments, from the perspective of the at least one user, this may result in a highly personalized itinerary planning process such that the suggestions may not only be relevant to their interests but may also be inherently safer and/or more suitable, delivered in real time. The integration of health data into the computational logic thus builds trust and confidence in the output of the integrated travel platform, as the user can be assured that behind each recommended trip, the processor of the integrated travel platform has thoroughly vetted the option against their unique health and/or safety parameters. Therefore, this aspect of the integrated travel platform may be configured to transform raw personal and/or environmental data into actionable itinerary customizations, enhancing the practical functionality of the travel platform in a way that meaningfully improves individual outcomes of the at least one user.

Accordingly, as shown in FIG. 3, in embodiments, the at least one multifactorial AI of the integrated travel platform may comprise at least one specific machine learning algorithm and/or at least one causal model, such that the integrated travel platform may be configured to continually learn from travel experience outcomes of the at least one user based on reviews and/or at least one digital token used. In this manner, the integrated travel platform may provide at least one recommendation to the fragmented travel service provider network in a designated travel location, based on the travel safety topics provided by the at least one user, on how at least one of the plurality of service providers may better align at least one service for the at least one user (e.g., a specific population of interest). For example, in some embodiments, if a diabetic association wants to have a conference in Orlando, the integrated travel platform may provide the at least one recommendation to the travel service provider network of a specific area and/or location (e.g., city, state, and/or country) (e.g., Orlando) to cater to the unique needs of a large number exceeding 3000 to 4000 diabetic patients. As such, in these other embodiments, the at least one recommendation may include making foot specialists available for diabetic foot-related issues, culinary services, events in destinations and/or theme parks that cater to the needs of the at least one user, and/or ensuring the services of the at least one of the plurality of service providers may be aligned with the needs of the at least one user.

FIG. 4 depicts an exemplary knowledge graph of the integrated travel platform, which represents the platform's ontology processing component. In embodiments, the knowledge graph may provide a semantic layer that links together the many concepts in the travel domain, including but not limited to users, profiles, safety topics, locations, services, and/or tokens, in a network of relationships. In this manner, the role of the knowledge graph can be to model these relationships explicitly, enabling more intelligent data integration and inference. For example, in some embodiments the knowledge graph might contain nodes for different vulnerable subpopulations of travelers (e.g., seniors, wheelchair users, immunocompromised individuals, etc.) and/or connect those to the specific services and/or accommodations those groups require. In addition, in these other embodiments, the knowledge graph may also link health conditions to travel advisories (e.g., a node for “Zika Virus” linked to nodes for regions where Zika is present, which in turn link to “pregnant travelers” as a group that needs to be cautious). By encoding domain knowledge in this way, the integrated travel platform may better personalize recommendations.

In addition, in embodiments, if a new category of user and/or a new risk factor emerges, the knowledge graph may be expanded by simply adding new nodes and edges, rather than reprogramming the core logic. In fact, the data model of the integrated travel platform can be designed to integrate at least one additional data point and/or remove one as needed when new vulnerable subpopulations or service providers are included. FIG. 4 illustrates this as a diagram of bubbles and arrows connecting “Traveler Profile” to various “Safety Topics” (health, crime, weather), which may then connect to “Destinations” and “Services.” If a new safety topic (e.g., a new disease outbreak) is introduced, the new node can be linked in the graph and immediately associated with relevant destinations and traveler profiles. The ontology processing enabled by the integrated travel platform, as shown in FIG. 4, may ensure that the platform's understanding of data is contextually rich, as the integrated travel platform may know not just raw numbers, but the meaning behind them and how one piece of information influences another in travel planning.

In embodiments, integrating the knowledge graph as an additional enhancement complements the existing AI and filtering algorithms. The AI can query the knowledge graph for reasoning tasks. For instance, in some embodiments, if a user's profile indicates they use a wheelchair, the AI can query the graph to find all services at a destination that are tagged as wheelchair-accessible and/or boost those in recommendations. Or, in some embodiments, if a user selects a safety topic like “air quality”, the knowledge graph may help identify which aspects of a travel package (e.g., transport, destination, season) relate to air quality and should be considered. As such, in embodiments, ontology processing means the integrated travel platform may infer new information: a simple example, if the graph knows “City A is in Country X” and “Country X has a Yellow Fever requirement for visitors,” then by transitive reasoning, any itinerary to City A should include a warning about Yellow Fever vaccination. Such inferences would be hard-coded rules in a normal system, but here they emerge naturally from the relationships in the knowledge graph.

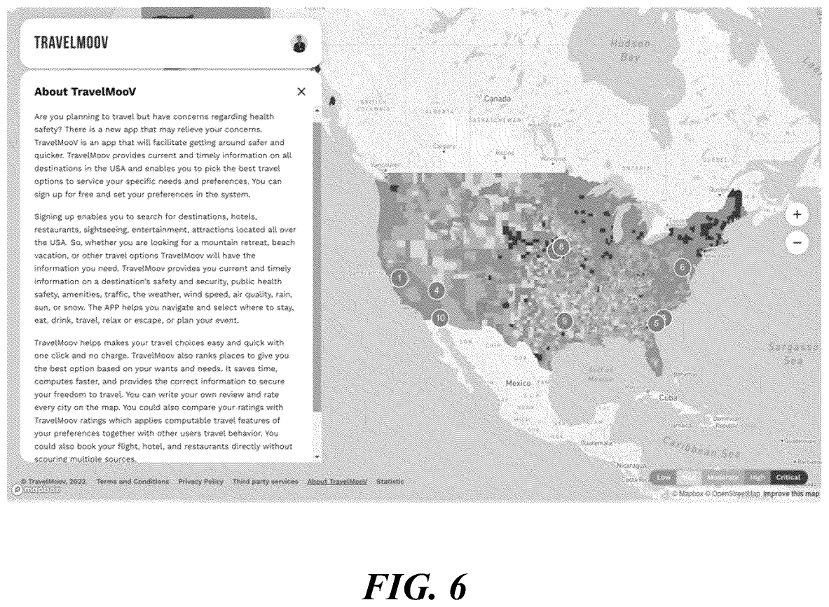

Therefore, as shown in FIG. 5 and FIG. 6, in embodiments, a data model, as provided below in equation (1), of the integrated travel platform may be configured to integrate at least one additional data point and/or remove at least one data point as the integrated travel platform updates and/or includes at least one additional vulnerable subpopulations and/or at least one additional service provider. Furthermore, in these embodiments, the integrated travel platform may be configured to educate the at least one of the plurality of service providers on how to cater to the needs of the newly included at least one additional vulnerable subpopulation within at least one of a plurality of designated travel locations. As such, the data model is provided below:

$${S}_{S} = {P}_{S} * 2 + {C}_{S} * 0.54 + {B}_{S} * 0.35 + {CM}_{S} * 0.11 \qquad ( 1 )$$

As provided in the equation above S_{S} represents a total safety score of the data model; P_{S} represents a Population Score; C_{S} represents an Infectious Disease (e.g., Covid-19) Prevalence Aggregate Risk Score; B_{S} represents a Personalized Risk Score, and CM_{S} represents a crime score.

Accordingly, in embodiments, the Population Score may be calculated by population of the city; the Infectious Disease Prevalence Aggregate Risk Score may be calculated as a total sum of new cases of at least one infectious disease for a city's county. For example, in some embodiments, the Infectious Disease Prevalence Aggregate Risk Score may be calculated over the past 14 days normalized per 100,000 county population. In addition, the Personalized Risk Score may be calculated as the sum of a predetermined amount of city businesses normalized per a predetermined amount of a city population. For example, in some embodiments, the Personalized Risk Score may be calculated as a total sum of city businesses normalized per 100,000 city population. Moreover, the Crime Score may be calculated as the number of crimes for the city normalized per the predetermined city population. For example, in some embodiments, the Crime Score may be calculated as the total number of crimes for the city normalized per 100,000 city population. Additionally, as shown in FIGS. 5-6, in embodiments, the ranges of the safety score may be presented as different colors on a travel safety map. As such, the ranges for the for the safety score may be defined dynamically and/or the ranges for the safety score of the data model may depend on the actual values at the specific moment of the time.

Accordingly, in embodiments, the integrated travel platform may comprise a personalized mode, in which the personalized mode comprises a total safety score as determined by the user defined categories and/or ranges (e.g., travel safety topics). In this manner, the personalized mode for the at least one user may be presented only when the at least one user may be logged into the specific profile associated with the at least one user within the memory of the integrated travel platform. Accordingly, in these embodiments, when the user returns to the integrated travel platform, the integrated travel platform may be configured to provide the user with a notification comprising and/or indicative of at least one travel package based on the travel behavior of the user, via the multifactorial AI.

Moreover, in embodiments, as stated above, the blockchain-based transaction system of the integrated travel platform may be configured to facilitate a minting, transfer, purchase, lease, and/or sale of at least one digital token (e.g., Non-Fungible Token (hereinafter “NFT”)). For example, in some embodiments, the integrated travel platform may be configured to mint, transfer, purchase, lease, and/or sale at least one Collab Token and/or at least one Evaluation Token. Accordingly, as shown in FIG. 3 and FIG. 4, in these other embodiments, the at least one multifactorial AI and/or blockchain-based transaction system of the integrated travel platform may comprise at least one service matching algorithm, such that the at least one multifactorial AI and/or blockchain may connect the user with at least one service provider. In this manner, the at least one service matching algorithm may be configured to create at least one innovative data architecture, such that the at least one service matching algorithm may be configured to combine at least one data microservice for each data shape and/or data type (e.g., infectious disease (e.g., Covid-19) prevalence and/or cases and/or personalized risk within an area, hotel and/or rental vehicle availability).

In embodiments, as disclosed above, the integrated travel platform may comprise at least one multifactorial algorithm executed by the at least one processor to compute a real-time personalized safety score for each prospective travel package. The safety scoring engine is a data-driven module that aggregates multiple quantitative indicators into a single composite metric (or set of metrics) indicative of travel risk and safety tailored to the user. As shown in FIG. 5 and FIG. 6, in conjunction with FIGS. 3-4, the data model of the integrated travel platform may be configured to integrate a variety of data points, including but not limited to crime rates, epidemiological data, population demographics, and/or user-specific risk factors, into the scoring calculations of the integrated travel platform. Each travel destination or package can be analyzed against this multifaceted criteria in real time. For example, in some embodiments, the safety score generator may evaluate an area by retrieving the local crime statistics (number of incidents normalized per 100,000 population), the infectious disease prevalence in that region (such as recent COVID-19 case rates over the past 14 days), and/or measures of how well the area can accommodate vulnerable subpopulations (for instance, density of healthcare services or availability of disability support infrastructure). In this manner, these inputs, combined with the user's own risk profile (e.g., the user's age or health condition may increase sensitivity to certain risks), can be processed through a weighted algorithm (e.g., the multifactorial algorithm) or causal model to yield a safety score for the travel package. The algorithmic logic may employ specific machine learning models trained to interpret how these factors interact, continually learning and/or refining the scoring as new data comes in or as the user provides feedback. By using a multifactorial approach, the platform moves beyond simplistic safety metrics to a nuanced and/or personalized assessment computed via specialized software modules in real time.

In embodiments, the data flow underpinning the safety scoring algorithm can also be optimized for both breadth of input and/or low-latency processing. The integrated travel platform may be communicatively coupled to multiple external data sources through secure APIs and/or data feeds to gather the raw factors for the safety model. For example, in some embodiments, the integrated travel platform may automatically pull updated crime data from law enforcement databases or open data portals on a regular schedule (e.g., weekly updates of city crime reports every Monday at 06:00 AM, cached into the platform's local database). Likewise, public health APIs may be queried daily for the latest infectious disease statistics in each destination (with results like virus prevalence or vaccination rates stored in memory at, say, 07:00 AM each day). In this manner, demographic and/or infrastructure data, such as population density or number of hospitals per capita, can be imported from governmental and/or third-party GIS services.

Additionally, in embodiments, the integrated travel platform may collect user-generated and/or historical data that feed into the Personalized Risk component of the safety score, such as the user's past travel reviews or indications of comfort levels which may be factored in via an AI analysis. All these disparate data inputs can be standardized into the internal data structures of the integrated travel platform and/or may be handled by distinct data microservices dedicated to each “safety topic” (one microservice for crime, another for health, another for user profile analytics, etc.). The computing device's architecture, via the integrated travel platform, thus can partition the data gathering tasks and/or then may combine the results in memory, enabling parallel processing of multiple safety factors. When the user initiates or updates a search, the processor of the integrated travel platform may rapidly assemble the latest values of all relevant metrics from its cache and perform the safety score computation almost instantaneously, yielding up-to-date risk assessments without perceptible delay.

Furthermore, in embodiments, the algorithmic logic for computing the safety score uses these inputs in a formula or model that is continuously adaptable. In these embodiments, the safety score might be calculated as a weighted function: Sₛ=f(P_{S}, C_{S}, B_{S}, CM_{S}), where each component represents a normalized sub-score for a particular safety dimension. For example, in some embodiments, a Population Score (P_{S},) may reflect the characteristics of the population at the destination, such as population density or the percentage of at-risk groups; an Infectious Disease Prevalence Score (C_{S}) may correspond to the recent trend of communicable disease cases in the area (normalized per capita); a Personalized Risk Score (B_{S}) might indicate the availability of services relative to population (for instance, number of health-related facilities or businesses per 1000 people, which serves as a proxy for how well a vulnerable traveler can be accommodated); and a Crime Score (CM_{S}),) may be derived from the frequency of crimes normalized by city population. As such, in embodiments, each of these sub-scores can be computed by the platform's analytics module using the latest data points (e.g., summing new disease cases in the last two weeks, or counting relevant city services) and/or normalizing them to standard scales. The multifactorial AI may then combine them (using either a predetermined formula or a learned model) to produce the overall safety score for the travel package or location. Importantly, in these embodiments, the algorithm may adjust weightings dynamically: if the user has indicated certain safety topics are more important (for example, a user highly concerned about health risks versus crime), the decision support algorithm can factor that preference by amplifying and/or attenuating the contribution of the corresponding sub-score. This configurable weighting can then be stored as part of the user's profile or session data in memory and/or may be applied on the fly during score computation, personalizing the result.

Additionally, in embodiments, the internal memory usage and/or data structures of the integrated travel platform can be tailored to support real-time safety scoring for potentially hundreds of travel options simultaneously. When the integrated travel platform presents a plurality of travel packages to the user (such as a list of hotel and activity bundles in a city), the integrated travel platform may also generate a safety score for each and caches these scores in the system's RAM or high-speed storage. Each travel package record in the platform's database may carry an attached safety score object that is updated whenever new data arrives or when the user modifies their parameters. The memory may further maintain historical safety score ranges for each location, enabling the platform to determine dynamically what constitutes a “low” or “high” score at that moment (since the model can define the color range of a safety map based on current distribution of scores). As new data points are integrated (e.g., for instance, if a city adds new healthcare facilities or if crime rates drop), the learning algorithms of the multifactorial AI of the integrated travel platform can update the stored model parameters in the background. As such, the learning algorithms may ensure that subsequent safety score calculations use the most current relationships between factors. For example, the integrated travel platform might learn that for certain vulnerable subpopulations (e.g., elderly travelers), healthcare access metrics should be given more weight; the integrated travel platform will then update its internal model coefficients accordingly in non-volatile storage. In this manner, the next time any user in that subcategory plans travel, the scoring algorithm, running in the at least one processor, can reflect this refined logic. Such adaptive memory-driven model updates exemplify how the safety scoring system continuously improves its accuracy and relevance, essentially optimizing itself as more data (both real-world statistics and user feedback) flows through the platform.

In embodiments, once computed, the personalized safety scores may be utilized by the platform in a variety of computational and user-interface functions to enhance decision-making. For example, in some embodiments, the integrated travel platform may use the safety score as a key sorting or filtering criterion when narrowing down travel results at step 208 of method 200, as shown in FIG. 2. In this manner, travel packages that do not meet a minimum safety threshold (determined by comparing the score against the user's acceptable risk level stored in their profile) can be automatically excluded from the results, conserving computational resources by not presenting options the user would likely reject. Additionally, in these other embodiments, the display device of the integrated travel platform (as part of the intuitive user interface) may be configured to visually render the safety scores for easy comprehension. In embodiments, as shown in FIG. 5 and FIG. 6, the integrated travel platform, via the at least one user interface and/or the display device may generate a colored map or annotated list where each travel option is marked with a color or icon corresponding to its safety score range, for example, green for high safety scores trending toward safe, yellow for moderate caution, and red for low safety scores indicating higher risk. This visualization may be generated by the graphics subsystem of the computing device, which pulls the safety score data from memory and applies a color mapping algorithm in real time. As such, in these embodiments, the user can thus glance at the interface and immediately grasp the relative safety of each option without parsing raw numbers. Behind the scenes, the graphical rendering may be linked to the data model such that if any underlying factor changes (say, new crime data comes in raising the risk level), the score can be recomputed and/or the map color updates dynamically without needing a full page reload. Such real-time feedback loops between the algorithmic core and/or the at least one user interface not only improve the user experience but also demonstrate the efficient management of data states and event-driven updates by the integrated travel platform within the software architecture.

In embodiments, the multifactorial real-time safety scoring mechanism provides technical advantages in terms of platform capability and user trust. By automating complex risk analyses that would otherwise require significant manual data gathering and expert interpretation, the system improves the speed and scale at which personalized safety assessments can be delivered. The user's computing device effectively acts as a specialized decision-support tool, leveraging large datasets and/or the at least one multifactorial AI to produce a single actionable metric (e.g., the safety score) on demand. From a performance standpoint, in these embodiments, the approach of the integrated travel platform of caching data and/or continuously updating scores means that when a user queries the safety of a location, the answer can be available almost instantly from memory, rather than requiring expensive on-the-fly computations from scratch. Moreover, the continual learning aspect of the multifactorial AI ensures that the algorithm becomes more efficient and accurate over time, for example, as it recognizes patterns (such as certain combinations of factors always leading to undesirable outcomes), the multifactorial AI can preemptively flag or prioritize options, reducing the need for trial-and-error by the user. By considering vulnerable subpopulations and individualized risk in the algorithm, the system goes beyond generic scoring, expanding the computing functionality to address personalized safety in travel, a technological improvement in the field of travel recommendation systems. Overall, the safety scoring feature not only bolsters user confidence (through transparent and easy-to-understand safety indicators) but also optimizes the platform's computational workflow by focusing resources on evaluating and presenting only those options that meet the user's multifaceted safety criteria.

Additionally, in embodiments, the at least one blockchain-based transaction system may be configured to allow the at least one service provider to tokenize each service the at least one service provider offers across any time. In addition, in these embodiments, the blockchain-based transaction system may be configured to enable the user of those services to purchase at least one reserve trade. As such, the tokenized services may comprise an efficient and/or transparent way that may build trust in the integrated travel platform based on a rich feature set of attributes.

In this manner, in embodiments, as shown in FIG. 3, the at least one digital token may be used by the user to facilitate travel planning, review, rating, transaction efficiency, booking, and/or any travel aspect known in the art related to travel planning, reviewing/rating, and/or booking. As such, the integrated travel platform may be configured to measure and/or determine the level of trust amongst all users comprising the at least one digital token. Accordingly, in these embodiments, the multifactorial AI may be configured to implement the level of trust, to verify an accuracy of the at least one travel package, and/or suggest continued selection of the at least one travel package to at least one of the plurality of users of the integrated travel platform.

In embodiments, the integrated travel platform may also be configured to generate at least one digital token (hereinafter “Collab Token”), such that at least one group of a plurality of service providers within a designated travel location, as determined by the at least one user and/or the integrated travel platform, with an alignment of services that cater to tourists with specific needs and/or profiles based on the at least one travel safety topic selected by the at least one user. Furthermore, in these embodiments, the integrated travel platform may be configured to determine how many Collab Tokens have been generated and/or provided to the at least one group of the plurality of service providers. In this manner, the integrated travel platform may be configured to determine a level of collaboration within the at least one group of service providers based on the at least one Collab Token issued to the at least one group of the plurality of service providers.

As such, in embodiments, the memory of the integrated travel platform may comprise at least one set of collaboration parameters (e.g., quick validation of travel package, group booking of airfare and rental vehicles), such that when the at least one group of the plurality of service providers successfully meets at least one of the set of collaboration parameters, the at least one group of the plurality of service provides may be provided at least one Collab Token by the integrated travel platform. Additionally, this embodiment, based on the total amount of Collab Tokens generated for the at least one group of the plurality of service providers, the integrated travel platform may be configured to incentivize, validate, and/or endorse the at least one group of the plurality of service providers within the designated travel location (e.g., city, state and/or regional government).

Accordingly, in embodiments, the integrated travel platform may also be configured to generate the at least one alternative digital token (hereinafter “Evaluation Token”). The at least one Evaluation Token may be a credit used in place of money for the purpose of making at least one specific and/or special request to at least one of the plurality of service providers in communication with the integrated travel platform. In these embodiments, the integrated travel platform may be configured to offer and/or generate the at least one Evaluation Token for a predetermined cost (e.g., U.S. Dollars). Furthermore, based on the specific and/or special request made by the at least one user to at least one of the plurality of service providers, a detailed specific and/or special request may require a larger amount of Evaluation Tokens as compared to a simple specific and/or special request. Additionally, in these embodiments, the integrated travel platform may be configured to associate an expiration date with the at least one Evaluation Token, such that, after the at least one user pays for the at least one Evaluation Token, the at least one Evaluation Token may be configured to expire a certain number of days before the intended travel date, as selected by the at least one user. For example, in some embodiments, when using the integrated travel platform to book a trip to Las Vegas, a request for a room with at least one King Bed may require less Evaluation Tokens than a request for a room with at least one King Bed with a view of the Las Vegas Strip.

Moreover, in embodiments, the integrated travel platform may be configured to determine and/or calculate the total amount of Evaluation Tokens generated for the at least one of the plurality of service providers within the designated travel location (e.g., city, state and/or regional government), such that the integrated travel platform may predict and/or forecast demand for the at least one of the plurality of service providers. Accordingly, in these embodiments the integrated travel platform may be configured to increase and/or decrease a total amount of Evaluation Tokens required for the specific and/or special request of the at least one user for the at least one of the plurality of service providers. In addition, the integrated travel platform may be configured to provide at least one destination and/or service recommendation based on the total amount of Evaluation Tokens issued for the at least one of the plurality of service providers within the designated travel location. In this manner, the integrated travel platform may be configured to suggest at least one alternative destination and/or alternative service recommendation to the at least one user after the at least one user has selected a destination and/or service with a lower total amount of Evaluation Tokens than the at least one alternative destination and/or alternative service.

In embodiments, as disclosed above, the integrated travel platform incorporates the blockchain-based transaction system as part of its underlying architecture to enhance democratization of data sharing, transparency of transactions, and trust-building among users and service providers. This blockchain-based transaction system may be communicatively coupled to the platform's core via at least one API and/or node interface, as shown in FIGS. 2-4, allowing the at least one processor of the platform to interact with a distributed ledger in real time. In addition, the integrated travel platform can leverage the blockchain's decentralized data structure to store and/or verify certain travel-related transactions and/or records (such as bookings, reviews, and token exchanges) in an immutable manner. By doing so, the platform ensures that no single entity (including the platform operator) can unilaterally alter critical records, fostering transparency and user trust. For example, in some embodiments, when a user books a personalized travel package or leaves a review for a service provider, the key details (transaction timestamp, service provider ID, user rating, etc.) may be hashed and/or written to a public and/or permissioned blockchain ledger as a transaction. All participants in the travel network (e.g., users, service providers, stakeholders) may then later verify the authenticity of those records through the ledger, which acts as a single source of truth. As such, in embodiments, the computing infrastructure of the integrated travel platform configured to support this may include blockchain client software running on the platform's server or cloud environment, which may interface with smart contracts governing the travel tokens and/or records. In this manner, the integrated travel platform can democratize the travel planning process by giving each user and/or service provider a verifiable stake in the network's data, ensuring that trust is established not by a central authority alone but by cryptographic validation across the distributed network.

In embodiments, a significant feature of the blockchain integration is the use of digital tokens to represent value, reputation, or access rights within the travel ecosystem. In embodiments, the integrated travel platform may mint and/or manage various types of tokens (for instance, the “Collab Tokens” and the “Evaluation Tokens”, as disclosed above) using the blockchain-based transaction system. As disclosed above, the Collab Tokens may be digital assets issued to groups of service providers to incentivize and/or measure collaboration, whereas the Evaluation Tokens may be issued to users to facilitate special service requests or to act as credits for transactions. The creation and transfer of these tokens can be executed via smart contracts deployed on the blockchain. For example, in some embodiments, when a plurality of service providers in a region come together to form a collaborative network addressing a specific traveler need (such as a network of hotels, clinics, and/or transportation services catering to diabetic travelers), the processor of the integrated travel platform may be configured to trigger a smart contract to mint a certain number of Collab Tokens to that provider group. These tokens, recorded on the blockchain ledger, can serve as a transparent record of at least one of the service providers contributions and/or collaborative achievements (e.g., completing a set number of successful bookings for vulnerable users). Additionally, in embodiments, the memory of the integrated travel platform may maintain a set of collaboration parameters (stored off-chain or in a side-database) that define when a Collab Token reward can be earned, such as meeting predefined targets like “quick validation of a travel package by all providers” or “executing a group discount for a family with special needs.” In this manner, in these embodiments, when those conditions are met (detected by the platform's monitoring module scanning booking and service data), the blockchain-based transaction system of the integrated travel platform may communicate with the blockchain network to issue the tokens to the providers' blockchain addresses. This process can be decentralized and transparent: each token issuance may be a blockchain transaction visible to the network, publicly acknowledging the collaborative effort of at least one of the service providers. The tokens can later be queried by any stakeholder to verify the level of collaboration and/or service quality, building trust that the providers have a history of verified cooperation in serving special-needs travelers.

Similarly, the Evaluation Token mechanism may integrate blockchain to empower users and/or ensure fairness in accessing specialized services. In embodiments, a user who requires a specific accommodation beyond standard offerings (for instance, a hotel room with particular medical equipment or a customized meal plan from a restaurant) may obtain an Evaluation Token through the integrated travel platform. As such, in these embodiments, the blockchain-based transaction system of the integrated platform, via the at least one user interface, may allow the user to purchase a certain amount of Evaluation Tokens (using conventional currency (e.g., U.S. Dollars, Euros, etc.) converted via the platform's smart contract at a predefined rate). In this manner, the Evaluation tokens may act as a decentralized voucher for making special requests. The user's request (with all its specific attributes) can then be linked to a token and/or broadcast to the network of service providers. Accordingly, in embodiments, the service providers receiving the request can trust the token as proof that the user has committed resources for this custom service (since the token is on-chain and possibly escrowed by the smart contract until fulfillment). Additionally, the algorithms of the integrated travel platform may adjust the number of tokens required for a given request based on real-time demand and supply data, for example, if many travelers are concurrently requesting private medical transport in a city (high demand), the platform (through a smart contract logic or off-chain oracle feeding into it) might increase the token cost for that service to allocate resources efficiently. In this manner, all this logic may be encoded and/or executed with transparency: token pricing adjustments and/or special request contracts are auditable on the blockchain, ensuring that users are charged in a predictable, rule-governed way without hidden intermediaries. Once the service provider fulfills the request (as confirmed by the platform, perhaps via an IoT confirmation or user acknowledgment through the UI), the smart contract can release the tokens to the account of the at least one service provider as payment or credit. The entire exchange (from request to fulfillment) may also then be logged on the ledger, creating a tamper-proof trail that builds trust between strangers (users and providers) by removing ambiguity about whether the request was met and compensation delivered.

In embodiments, the blockchain-based transaction system may also enhance the platform's ability to measure and/or improve trustworthiness across the travel network through transparent reputation management. In these embodiments, the integrated travel platform may also track user and/or service provider reputation by analyzing on-chain data such as token distribution and usage patterns. For example, in some embodiments, each profile of the user may be associated with a certain trust level or rating that increases when they engage positively in the ecosystem (booking trips, providing helpful reviews, completing transactions without dispute) and/or possibly when they hold or have been rewarded with particular tokens (like tokens given for writing verified reviews or for being a repeat customer of collaborative providers). As such, in embodiments, the multifactorial AI of the platform may ingest these blockchain-sourced metrics as additional features when generating recommendations. If a certain travel package is offered by a service provider group that has earned many Collab Tokens (indicating a high collaboration and reliability level) and/or also has consistently high user ratings logged on-chain, the AI of the integrated travel platform may boost the visibility or explicitly flag of that package it as “high-trust” to the user. Technically, this involves querying the blockchain (either through a node or a cached middleware service) for the count of tokens and the historical transactions of a provider, then storing a trust score in the local database (e.g., the memory of the computing device) of the integrated travel platform for quick access. At runtime, in these embodiments, the processor can execute instructions to verify aspects of a travel package's data against the blockchain records, for example, confirming that the pricing or availability information presented has not been tampered with by cross-referencing a cryptographic hash and/or token that was generated when the data was first cached. In this manner, in embodiments, if inconsistencies are found, the blockchain-based transaction system of the integrated travel platform can automatically refresh the data via a trusted source or alert the user. Thus, blockchain integration not only secures transactions but actively feeds into the verification logic of the platform, enabling real-time auditing of data accuracy and consistency.

From a network perspective, in embodiments, the blockchain-based transaction system of the integrated travel platform can democratize the travel platform by allowing interoperability with other systems and stakeholders without requiring direct database access. Because standardized tokens and ledger records are used, third-party travel services or even municipal tourism boards could directly plug into the ecosystem. For example, in some embodiments, a local tourism authority might issue its own tokens on the same blockchain as the blockchain-based transaction system to reward travelers for visiting off-beat health retreats or museums, which the integrated travel platform can recognize and accept as input (the API of the integrated travel platform could read those tokens in the wallet of the user to tailor recommendations accordingly). This open, decentralized design can break down the silos of traditional travel industry data, smaller service providers and/or community groups can contribute information or offer packages by simply interacting with the blockchain layer, without needing a privileged integration with the internal database of the integrated travel platform. In this manner, in embodiments, the software of the integrated travel platform may be configured to monitor the relevant blockchain smart contracts and/or can automatically incorporate any new tokenized offer or update that appears on-chain (e.g., a new provider issues an NFT for a health-focused local experience; the platform detects this on the ledger and adds it to the available inventory if it meets the criteria). By decentralizing key aspects of data and transaction management, the integrated travel platform may improve not only transparency and trust but also scalability and resilience: even if parts of the platform's centralized infrastructure experience issues, the critical records and value tokens persist on the distributed ledger, and/or can be independently verified or even transacted by users outside the core platform if necessary. As such, the integrated travel platform may ensure continuity of trust. Furthermore, security can be enhanced, cryptographic mechanisms of the blockchain-based transaction system prevent unauthorized modification of records and/or provide a built-in consensus verification for transactions, reducing the risk of fraud in bookings or false information in reviews.

In embodiments, the integrated travel platform is configured to facilitate and nurture collaborative networks among a plurality of diverse service providers, including but not limited to travel, health, and safety-related services, in order to deliver holistic travel solutions for users with specific needs. The system architecture of the integrated travel platform may support this by allowing each service provider to register a profile within the memory of the integrated travel platform (as disclosed above, providers create accounts detailing their offerings and/or capabilities). As such, the profiles may then be stored in a structured provider database and/or may include metadata tags indicating the type of services offered (e.g., hotel, pharmacy, emergency clinic, accessible transportation, personal caregiver, tour guide, etc.) and/or any specialties (such as “diabetic-friendly meals” or “wheelchair-accessible vans”). In this manner, the at least one processor of the integrated travel platform may execute a service matching algorithm that actively analyzes the profile data of the plurality of service providers to identify which providers complement each other in serving particular traveler segments. For example, in some embodiments, the algorithm may cluster providers by geography and service type to form potential networks, such as grouping a medical supply rental service with a nearby hotel and a local hospital if all are in the same city and can collectively meet the needs of travelers with disabilities. These groupings are not static; the platform can dynamically update associations in memory based on real-time data like current availability and the specific requirements coming from user queries. As such, in embodiments, by maintaining an up-to-date graph or network model of providers (e.g., nodes representing providers and edges representing potential or existing collaborations), the integrated travel platform may quickly assemble a “team” of services to fulfill a complex itinerary request. In essence, in these embodiments, the integrated travel platform may act as a matchmaking and/or coordination engine, using data-driven insights to build ad-hoc coalitions of service providers tailored to the user's travel objectives and constraints.

Moreover, in embodiments, when a user initiates a travel planning session with particular safety or health parameters, the at least one multifactorial AI of the integrated travel platform may not only search for individual travel packages but also consider composite packages that span multiple providers. Internally, at step 206 of method 200, as shown in FIG. 2, in these embodiments, after parsing the user's parameters, the platform may query its database for sets of services that together satisfy the criteria. For example, in some embodiments, if a user indicates a need for “accessible transport, allergen-free meals, and dialysis treatment during trip,” the integrate travel platform can identify providers in the target destination for each of these needs. The service matching algorithm running in the processor may then evaluate combinations of those providers to find an optimal match (perhaps a specific hotel that offers special meals, a transport company with wheelchair vans, and a clinic that accepts short-term dialysis appointments). As such, in embodiments, the at least one multifactorial algorithm of the integrated travel platform may consider compatibility factors stored in the providers' profiles (such as whether the clinic is within a reasonable distance of the hotel, or whether the timing of transport can align with clinic appointments) and/or may use constraint-satisfaction logic to eliminate incompatible groupings. In this manner, if multiple viable provider networks are found, the integrated travel platform can rank them based on historical performance data or user ratings (for example, preferring a network of providers that has collectively served similar travelers successfully in the past). These computations may involve intensive database joins and/or possibly graph traversal algorithms, all of which the backend of the integrated travel platform may handle using indexing and/or caching strategies to manage the large volume of provider data. By the time the user is presented with itinerary options, each option might be backed by a ready-assembled network of different service providers seamlessly coordinated by the platform, even though to the user it appears as a single integrated travel package.

To further encourage and formalize these collaborations, in embodiments, the integrated travel platform may implement programmatic incentives and/or tracking via the aforementioned blockchain tokens and internal metrics. As discussed above, the Collab Tokens can provide a measurable incentive for providers to work together. The integrated travel platform can monitor collaborative events, for example, when two or more providers participate in fulfilling one itinerary of at least one user, that event can be logged in the memory of the integrated travel platform (e.g., the memory of the computing device) and/or can be potentially written to the blockchain for token issuance. As such, in these embodiments, the integrated travel platform may set criteria (stored as collaboration parameters) including but not limited to examples such as “group responded to booking inquiry within X hours” or “all services in package delivered successfully without incident” and/or when such criteria are met by a provider group, the at least one processor of the integrated travel platform may trigger the reward mechanism (smart contract call to grant a Collab Token or adding a positive collaboration score in the internal database). As such, over time, service providers that consistently collaborate earn a higher collaboration score, which the integrated travel platform can use in its algorithms (e.g., the at least one multifactorial AI). For example, when matching providers for a new user request, the integrated travel platform may favor grouping providers who have a history of successful cooperation (as indicated by tokens or high internal collaboration ratings). This creates a feedback loop: reliable networks get more recommendations, which leads to more business and further incentive to maintain high service levels. From a computing standpoint, in embodiments, the integrated travel platform can maintain a ledger of provider collaborations and/or token awards (e.g., the blockchain-based transaction system) that is referenced during each new matchmaking computation, this is essentially a reputation subsystem for provider networks. By storing this data on a distributed ledger (blockchain) as well as locally, the integrated travel platform can ensure that the collaboration records are transparent and/or tamper-proof, which further motivates service providers to contribute their best efforts knowing that their collaborative reputation directly affects their visibility to users.

In embodiments, the integrated travel platform may also provide communication and/or interface layers to facilitate real-time coordination among service providers in a network. In these embodiments, once a group of providers is assembled for an itinerary (either pre-defined or on-the-fly), the integrated travel platform can open a secured communication channel and/or share a common dashboard with those providers through an API or provider-side application. For example, in some embodiments, the at least one processor and/or software of the integrated travel platform may expose a scheduling interface where the transportation provider can see a flight arrival time of the at least one user from the airline provider and automatically schedule a pickup, or where a hotel can see that the user will require a specialized meal upon check-in and notify their kitchen staff accordingly. As such, in embodiments, these interactions may be mediated by the server of the integrated travel platform, which can relay relevant pieces of the itinerary and profile of the at least one user (with privacy controls) to each provider as needed. The data exchange can also be handled via secure web services or messaging queues, ensuring service providers get timely updates.

In this manner, in embodiments, the integrated travel platform may use standard data formats for these exchanges (like JSON or XML with predefined schema for itinerary events) to allow even third-party systems at the providers' end to ingest the information if they have their own software. This real-time provider network communication may be crucial for delivering a seamless user experience (it effectively turns a collection of independent services into a synchronized virtual “travel team” for the user). Additionally, the coordination engine of the integrated travel platform may also monitor confirmations from each provider: for example, the transport provider might send a confirmation when the pickup is scheduled, which the platform logs; if any provider flags an issue (e.g., a sudden unavailability), the platform's processor can proactively seek an alternate provider from the network and/or can adjust the itinerary, notifying both the user and the remaining providers of the change. All of this may be done rapidly through automated rules and/or, if applicable, AI-based predictions (such as anticipating weather disruptions and advising providers ahead of time). The result can be a resilient collaborative network that can adjust on the fly via the computing intelligence of the integrated travel platform, minimizing disruption to the traveler.

This collaborative network building yields substantial improvements in how the computing platform performs and what it offers. In addition, in embodiments, from a system performance perspective, having an ecosystem of integrated service providers means the integrated travel platform may be configured to cache and/or reuse a lot of interrelated data. For example, in some embodiments, if a certain provider combination is frequently used, the at least one processor and/or software of the integrated travel platform can keep a template of that combined offering in memory (e.g., the memory of the computing device and/or server), avoiding recalculating the whole network each time, much like caching a composite service package. In this manner, the at least one processor and/or software can also reduce external API calls: once service providers are linked through the platform, information like availability and/or pricing can be shared internally via the databases of the integrated travel platform rather than querying each provider separately for every user request.

As such, in embodiments, the collaboration engine, via the integration of the databases of the integrated travel platform, can lower network overhead and/or speeds up response times. From the user's perspective, in embodiments, the advantage is an all-in-one planning interface that addresses niche needs without the user having to manually coordinate between multiple vendors. For example, in some embodiments, the ability of the integrated travel platform to suggest, for instance, “Package A: includes Hotel X (with oxygen facilities), Car Service Y (wheelchair accessible), Clinic Z (on-call doctor visit), all coordinated for your dates” can be a direct result of its collaborative network intelligence, via the collaboration engine. This can improve user experience by providing reassurance that every aspect of their safety and comfort is handled collectively. Moreover, in these embodiments, the integrated travel platform can democratize which service providers get exposure: not only the largest hotel chains or tour companies are recommended, but also small, specialized providers (like a local caregiver service) find their way into major itineraries because they are matched where relevant. By building and managing these collaborative networks through software, the invention transforms a fragmented service landscape into a unified, efficient system that can deliver complex, health-conscious travel experiences reliably and at scale.

Referring again to FIG. 2, next, at step 214, the integrated travel platform then queries the travel package via the use of the at least one ARI and/or the at least one API to collect and cache the most recent travel safety data topic to determine the real-time pricing and availability of the travel package.

At step 216, as shown in FIG. 2, the integrated travel platform compares the received real-time price and/or availability cached from the at least one ARI and/or the at least one API to the cost and/or availability originally cached from the initial search using the at least one ARI and/or the at least one API. The method then proceeds to either step 218 or step 220 depending on whether a substantial match exists between the real-time price and/or availability and the original price and/or availability. In some embodiments, the integrated travel platform may regularly update the original price at predetermined intervals to maintain accuracy of the real-time availability and/or rates.

During step 218, the integrated travel platform determines that a substantial match does not exist between the real-time price and/or availability of the travel package and the original price and/or availability. As such, during step 218, the integrated travel platform executes instructions to activate a notification, presenting the information to the user. In some embodiments, the integrated travel platform associated with the computing device may verbalize the notification of the integrated travel platform.

During step 220, the integrated travel platform may determine that a substantial match does exist between the real-time price and/or the availability of the travel package and the original availability and/or price. Accordingly, during step 220, the integrated travel platform directs the user to the booking page, presenting the user with the real-time price and/or availability of the travel package.

Furthermore, at step 222 of method 200, in embodiments, the integrated travel platform presents the user a booking summary on the booking page, including but not limited to room selection, cancellation terms and/or refund terms. In these embodiments, the integrated travel platform may automatically enter the personal and/or the payment information of the user to optimize the booking process for the user. Next, at step 224, the integrated travel platform may be configured to automatically book the aspects of the travel package, via at least one API, using the personal and/or the payment information of the user, increasing the efficiency of the travel booking of the user.

Finally, as shown in FIG. 2, in embodiments, method 200 may proceed to step 226, in which the integrated travel platform may provide the user with an acceptance page, confirming successful booking of the travel package. In these embodiments, if an issue arises within the booking process, the integrated travel platform may be configured to provide the user a notification of the error and/or, subsequently, with several solutions to alleviate the booking issue. Additionally, in some embodiments, the notification of the error may be provided to the user, via any auditory, tactile, and/or haptic means known in the art by the integrated travel platform, via the at least one processor of the computing device.

In embodiments, as disclosed above, the integrated travel platform may comprise an intuitive graphical user interface (GUI) (i.e., the at least one user interface) designed to accept detailed health-related inputs from the user and/or to interact with backend services for real-time availability and pricing validation. As shown in FIG. 5 and FIG. 6, the user interface of the integrated travel platform can provide a configuration where the user can specify personal health and/or safety parameters in a structured, user-friendly manner. For example, in some embodiments, the GUI may present the user with a menu and/or form listing various safety topics and health considerations, including but not limited to checkboxes or sliders for climate preferences (temperature and humidity ranges), fields for medical conditions or allergies, and toggles for required accommodations (wheelchair access, proximity to hospitals, diet restrictions).

As such, in embodiments, the GUI might be organized as a multi-step input wizard: one step allowing the user to select their primary safety topics of concern (e.g., “Air Quality” or “Crime Rate”), and/or subsequent screens to input precise thresholds or personal data related to those topics (e.g., selecting an air quality index range or indicating a health condition that makes the user sensitive to pollution). Throughout this process, the GUI can be configured to guide the user with visual cues and validations, for example, disabling incompatible options or highlighting recommended inputs based on previous selections. All user inputs can then be captured via the at least one GUI and/or transmitted to the processing backend (e.g., the at least one process) of the integrated travel platform in real time using asynchronous calls (such as AJAX requests in a web implementation or background API calls in a mobile app). In this manner, the GUI (i.e., the at least one user interface) can be thus closely integrated with the system's computational core: every time the user adds or changes a health parameter, the platform immediately receives and/or logs this new data point in the user's session profile in memory.

As the user provides their parameters, in embodiments, the at least one user interface (e.g., the GUI) can respond by dynamically updating the travel options and/or information displayed, ensuring that the output always reflects the latest input. In conjunction with FIG. 2, at step 204 for example, in some embodiments, once the user has inputted a set of safety and health parameters, the integrated travel platform can backend query, via the at least one processor, its databases and/or external sources for matching travel packages (step 206 and 208). In this manner, in these other embodiments, the results of this query may be sent back to the user's device and/or the GUI can automatically present a narrowed plurality of travel packages via the interface. This presentation might occur as an interactive list or map on the screen showing only those destinations and packages that meet the criteria of the at least one user.

In embodiments, the at least one user interface (GUI) can be configured to handle this in real time, meaning there is minimal delay between parameter input and seeing the filtered results. As such, the GUI may implement this with reactive programming models and/or real-time data binding: for example, using WebSocket connections or long-polling to continuously fetch updated recommendations as the user tweaks filters. In addition, each travel package entry displayed can include key details (name, brief description, price, etc.) alongside indicators derived from the user's inputs, such as icons and/or badges for health and safety features (a stethoscope icon for nearby medical facilities, a leaf for good air quality, etc.), giving immediate visual affirmation that the package aligns with the entered parameters. Furthermore, in embodiments, the user can further interact with the results by sorting or drilling down for more details, and the GUI may maintain context, showing, for instance, the safety score (computed earlier by the multifactorial algorithm) for each item in a color-coded manner directly on the list or map. By designing the GUI to be data-driven and/or stateful (maintaining the user's selections in memory and updating the display accordingly), the integrated travel platform may deliver a seamless interactive experience where complex calculations and database operations happen behind the scenes without disrupting the exploratory flow within the integrated travel platform by the at least one user.

In embodiments, a significant aspect of the at least one user interface (GUI) configuration is how it manages the transition from planning to booking while performing real-time validation of availability and pricing. As such, in these embodiments, when the user selects a particular travel package from the narrowed results (triggering step 210 in FIG. 2), the GUI can move to a booking workflow (often showing a summary or a dedicated booking page). As such, before finalizing the booking, the integrated travel platform may perform a real-time check (See FIG. 2 at steps 212, 214, 216) to ensure that the details of the selected package are up-to-date and/or accurate. The GUI can be intimately involved in this process: upon the selection of the at least one user, the GUI may display a loading indicator or a message like “Validating availability and price . . . ”.

In the background, in embodiments, the backend processing (e.g., the at least one processor) of the integrated travel platform may use at least one ARI (Availability and Rate Interface) and/or API to query the systems of at least one of the service providers for the latest availability slots and current pricing of the selected travel components (hotel room, flight seat, event ticket, etc.). The results of these live queries can then be returned to the platform, which may compare them to the data originally cached when the package was first presented. Within a fraction of seconds, the integrated travel platform may determine if there is a “substantial match” between the previously shown price/availability and the real-time data. In this manner, in these embodiments, the GUI then may react based on the outcome: if the information still matches (the package is available at the quoted price), the interface seamlessly proceeds to the booking confirmation step (as in step 220), displaying the real-time verified price and available options. For example, in some embodiments, if there is a discrepancy, for instance, if the price changed or one component is no longer available (step 218 scenario), the GUI can immediately notify the at least one user. This notification can be multi-modal: a pop-up dialog or highlighted text on the screen informing “The selected package has changed, here are the updated details,” possibly accompanied by an auditory alert or vibration on a mobile device for emphasis. As such, in embodiments, the GUI may be designed to handle these real-time updates gracefully, perhaps by offering the user alternatives (e.g., “Package no longer available, click here to see similar packages or updated results”) and/or by refreshing the current selection's details to reflect the new price and asking the user to confirm if they still wish to proceed. Because the integrated travel platform can anticipate these checks and can build them into the flow, the user is kept informed at all times, preventing scenarios where they might unknowingly attempt to book an outdated offer.

Furthermore, in embodiments, the user interface (GUI) may also feature a configuration for displaying a booking summary and/or collecting final confirmations, which ties into the system's optimized booking execution. For example, in some embodiments, once a package may be validated and the user proceeds, the GUI may be configured to present a summary page (step 222 of FIG. 2) detailing all components of the itinerary, including but not limited to, travel dates, chosen services, safety score recap, pricing breakdown, cancellation policies, and any health-specific notes (like “all meals will be gluten-free as requested”). Importantly, in embodiments, because the user's personal and payment information may be stored securely in the platform's memory (often saved in the user's profile after account creation), the GUI can auto-populate the booking form with those details. The user may then see their name, contact info, passport number, or payment method already filled in, with the option to edit if needed, drastically reducing the time required to complete the transaction.

In embodiments, the secure memory retrieval of the integrated travel platform can ensure sensitive data is inserted only on the client-side interface after proper authentication (e.g., the user being logged in and possibly passing a two-factor check), thus maintaining privacy while improving convenience. When the user clicks the final “Book Now” or equivalent action (step 224 of FIG. 2), the GUI may relay this confirmation to the backend, which in turn executes the booking through the relevant APIs (for instance, sending the reservation request to a hotel's system or an airline's ticketing API). Throughout this process, the GUI provides feedback (a progress bar or messages like “Booking your itinerary . . . ”) as the system communicates with third-party services in real time. Upon successful booking, in embodiments, the GUI may immediately transition to an acceptance or confirmation page (step 226) that thanks the user and/or may display the confirmation details (booking reference numbers, and possibly a QR code or digital ticket). If any issue arises during booking (such as a payment processing error or a last-moment unavailability), the GUI may be configured to handle it by showing an error notification along with actionable solutions (e.g., “Payment failed-please enter a new card or try again” or “The flight segment could not be booked, would you like to search for a different flight?”). As such, in these embodiments, by linking the actionable solutions of the GUI with backend logic, the platform ensures that even error conditions result in a guided experience rather than user confusion. Furthermore, the GUI may utilize tactile or haptic feedback on supported devices to draw attention to urgent notifications (for instance, a slight phone vibration when a real-time price change alert appears), leveraging device capabilities to enhance user awareness in critical moments.

From a technical perspective, in embodiments, the GUI configuration may be tightly integrated with the databases and/or network interfaces of the integrated travel platform to achieve real-time responsiveness. As such, the integrated travel platform can employ caching strategies on the client side as well; for example, static data (like lists of safety topics, icons, or general info about destinations) may be cached in the app or browser so that the GUI can load instantly and only dynamic content (like search results or availability changes) require network calls. This reduces perceived latency and load on the server of the integrated travel platform. Meanwhile, the structure of the GUI input may be aligned with the backend data models: each field or selection in the interface corresponds to a parameter in the search query or booking request object of the integrated travel platform. This alignment means minimal transformation is needed when the GUI sends data to the server, speeding up processing.

In embodiments, the GUI can also enforce data validation at the client side, for example, if a user enters an age or a date outside allowable ranges, the interface will prompt correction before sending the data, which prevents unnecessary round trips and/or helps maintain data integrity within the integrated travel platform. In terms of improving computing performance, the interactive GUI may also reduce the overall number of full search queries by narrowing choices as the user filters (saving CPU and database cycles that would be wasted on irrelevant results). In these embodiments, the GUI may also reduce booking failures by catching discrepancies via the ARI/API validation before they become errors-this means the integrated travel platform may not have to handle as many rollback or refund operations, which can be costly in terms of both computation and transaction fees. The net effect may be a highly efficient human-computer interaction loop: the user gets immediate, accurate information and feedback, and/or the integrated travel platform can conserve resources while providing richer functionality. By allowing detailed user input and synchronizing it with live system checks, this aspect of the invention ensures that the final output (the booked travel itinerary) may be optimal and/or reliable, reflecting exactly what the user expects and needs at that moment, a result of numerous behind-the-scenes computational optimizations made visible through a well-crafted user interface.

The advantages set forth above, and those made apparent from the foregoing description, are efficiently attained. Since certain changes may be made in the above construction without departing from the scope of the invention, it is intended that all matters contained in the foregoing description or shown in the accompanying drawings shall be interpreted as illustrative and not in a limiting sense.

### INCORPORATION BY REFERENCE

All publications, patents, and patent applications mentioned in this specification are herein incorporated by reference to the same extent as if each individual publication, patent, or patent application was specifically and individually indicated to be incorporated by reference. To the extent publications and patents or patent applications incorporated by reference contradict the disclosure contained in the specification, the specification is intended to supersede and/or take precedence over any such contradictory material.

It is also to be understood that the following claims are intended to cover all of the generic and specific features of the invention herein described, and all statements of the scope of the invention which, as a matter of language, might be said to fall therebetween.

What is claimed is:

1. A computing device implemented method for providing and booking a personalized health travel itinerary, executed by a computing device comprising at least one processor and at least one memory, the method comprising:
(a) rendering, via the at least one processor, a plurality of travel packages and a plurality of safety topics on a display device associated with the computing device, and caching the rendered plurality of travel packages in the at least one memory;
(b) executing, by the at least one processor, a search routine that narrows the plurality of travel packages in the at least one memory based on a received set of parameters and stores search result data in the at least one memory;
(c) receiving, from the user via the at least one user interface, a selection of one travel package from the narrowed plurality of travel packages;
(d) querying, in response to the selection, at least one Availability and Rate Interface (ARI) and at least one Application Programming Interface (API) to retrieve, in real time, pricing and availability for the selected travel package;
(e) comparing, by the at least one processor, the real time pricing and availability to the cached search result data to determine whether a substantial match exists;
(f) upon determining that the substantial match exists, automatically storing booking data for the selected travel package in the at least one memory and transmitting, via the at least one API, a booking request to at least one service provider system, and providing, in real time, a success notification to the user via the display device; and
(g) upon determining that the substantial match does not exist, invalidating the cached search result data for the selected travel package in the at least one memory, providing, in real time, an unsuccessful booking notification to the user, and automatically returning to step (b) to regenerate the narrowed plurality of travel packages based on the set of parameters.

2. The method of claim 1, further comprising periodically updating, via the at least one processor, the cached search-result data at predetermined intervals to maintain accuracy of pricing and availability prior to execution of step (d).

3. The method of claim 1, wherein the at least one processor reads, from an external health-and-safety information system via the at least one API, hospital-network location data and pharmacy-availability data, and stores corresponding metadata in the at least one memory for incorporation into the travel packages.

4. The method of claim 3, further comprising automatically capturing, in real time, at least one disease condition for a travel location selected by the user and updating a user profile stored in the at least one memory to suggest an alternative travel package based on the captured disease condition.

5. The method of claim 4, wherein the integrated travel platform includes a multifactorial artificial-intelligence module that ranks travel locations from optimally suited to worst-suited based on at least one user preference and stores the ranking in the at least one memory.

6. The method of claim 1, wherein presenting the plurality of safety topics comprises rendering a color-coded map having safety scores corresponding to the plurality of travel packages on the display device.

7. The method of claim 6, wherein the integrated travel platform associates at least one preference profile with the at least one safety topic, allowing the user to retrieve the at least one safety topic by selecting the at least one preference profile via the at least one user interface.

8. A system for automatically providing and booking a personalized health travel itinerary, the system comprising:
at least one processor;
at least one memory; and computer-readable instructions which, when executed by the at least one processor, cause the system to perform operations comprising:
(i) caching a plurality of safety topics and travel packages in the at least one memory and providing the plurality of safety topics on a display device;
(ii) receiving, via at least one user interface, a set of parameters from a user based on at least one of the plurality of safety topics and narrowing the cached travel packages accordingly;
(iii) responsive to user selection of at least one of the plurality of travel packages, querying at least one ARI and at least one API to retrieve real-time pricing and availability, comparing the retrieved data to cached data, and conditionally booking the selected travel package based on a substantial-match determination in the at least one processor; and
(iv) generating, in real time, either (A) a success notification and booking confirmation when the substantial match exists or (B) an unsuccessful-booking notification and an updated plurality of travel packages when the substantial match does not exist.

9. The system of claim 8, wherein the at least one user interface comprises a graphical user interface of a website or mobile application of the integrated travel platform configured for itinerary planning.

10. The system of claim 9, wherein the graphical user interface presents a score computed by the multifactorial artificial-intelligence module based on a decision-support algorithm utilizing curated public and private data sources in real time.

11. The system of claim 8, wherein the at least one processor executes a collaborative filtering algorithm that incorporates datasets provided by at least one external service provider to retrain travel-package recommendations.

12. The system of claim 11, wherein the at least one memory includes a distributed-ledger memory that captures real-time health-status data for travel destinations and triggers itinerary adjustments when a travel advisory or outbreak alert is detected.

13. The system of claim 12, wherein the blockchain-based transaction system searches and caches data for the plurality of safety topics within a travel package via the at least one API.

14. A computing infrastructure for an integrated travel platform, the computing infrastructure comprising:
an integrated travel platform having at least one processor and at least one memory;
a blockchain-based transaction system communicatively coupled to the integrated travel platform and configured to mint, transfer, and record digital tokens representing travel services on a distributed ledger via smart contracts; and
an ontology processing component storing a knowledge graph that semantically links users, profiles, safety topics, locations, services, and tokens to enable contextual inference within the integrated travel platform.

15. The computing infrastructure of claim 14, wherein the blockchain-based transaction system facilitates minting, transfer, purchase, lease, or sale of digital tokens to enhance transaction efficiency on the integrated travel platform.

16. The computing infrastructure of claim 15, wherein creation and transfer of the digital tokens is executed via smart contracts deployed on the blockchain-based transaction system.

17. The computing infrastructure of claim 16, wherein the blockchain-based transaction system is coupled to a core of the integrated travel platform via at least one API such that the at least one processor interacts with the distributed ledger in real time.

18. The computing infrastructure of claim 17, wherein the blockchain-based transaction system records travel-related transactions immutably on the distributed ledger, enabling subsequent verification by platform participants.

19. The computing infrastructure of claim 14, wherein the knowledge graph links users, profiles, safety topics, locations, services, and tokens to model contextual relationships between traveler profiles, safety parameters, destinations, and services.

20. The computing infrastructure of claim 19, wherein the integrated travel platform queries the knowledge graph to infer vaccination requirements for a destination and inserts a vaccination warning into any itinerary that includes the destination.
